(19) United States
(12) Patent Application Publication
(10) Pub. No.: US 2024/0180192 A1
(43) Pub. Date: Jun. 6, 2024

(54) Texture Enhancer for Protein Ingredient-Containing Food, and Method for Enhancing Texture and Method for Manufacturing Protein Ingredient-Containing Food by Using Same

(71) Applicant: KITII Corporation, Tokyo (JP)

(72) Inventors: Hiroyuki Asaki, Tokyo (JP); Hitoshi Kanai, Tokyo (JP); Kota Miura, Tokyo (JP)

(21) Appl. No.: 18/285,579

(22) PCT Filed: Jun. 13, 2022
(86) PCT No.: PCT/JP2022/023555

§ 371 Date: Oct. 4, 2023

(30) Foreign Application Priority Data
Jun. 14, 2021 (JP) 2021-098769

(51) Int. Cl. A23J 3/22; A23J 3/04; A23J 3/14; A23L 29/00; A23L 29/256

(52) U.S. Cl. CPC A23J 3/225; A23J 3/04; A23J 3/14; A23L 29/015; A23L 29/06; A23L 29/256

(57) ABSTRACT

Texture of a protein ingredient-containing food (especially a retort food) is maintained and a yield of the food is improved by using a texture enhancer for the food. This disclosure relates to a texture enhancer for a protein ingredient-containing food. This texture enhancer includes: (a) an alkaline agent, (b) a protein, (c) a protease, and (d) a common salt. Another texture enhancer includes: (a) an alkaline agent, (b) a protein, (c) a protease, (d) a common salt, and (e) an alginate, and can optionally include (f) a calcium salt. This disclosure relates to a method for enhancing texture of a protein ingredient-containing food and a method for manufacturing a protein ingredient-containing food by using the above texture enhancer.

### CROSS-REFERENCE TO RELATED APPLICATIONS

This application is the United States national phase of International Application No. PCT/JP2022/023555 filed Jun. 13, 2022, and claims priority to Japanese Patent Application No. 2021-098769 filed Jun. 14, 2021, the disclosures of which are hereby incorporated by reference in their entireties.

### BACKGROUND OF THE INVENTION

### Field of the Invention

This disclosure relates to a composition for enhancing texture of a protein ingredient-containing food, and a method for enhancing texture and a method for manufacturing a protein ingredient-containing food by using the same. This disclosure especially relates to a composition (texture enhancer) for enhancing texture of a protein ingredient in a retort food comprising the protein ingredient including seafood such as shrimp and clam and livestock meat such as pork, beef, and chicken. This disclosure further relates to a method for enhancing texture of a protein ingredient-containing food and a method for manufacturing a protein ingredient-containing food by using the texture enhancer. This disclosure also relates to a protein ingredient-containing food comprising the above-mentioned texture enhancer.

The present application claims the priority of Japanese Patent Application No. 2021-098769, the entire content of which is incorporated herein by reference.

### Description of Related Art

Foods comprising protein ingredients, especially retort foods containing seafood such as shrimp and clam and livestock meat such as beef, pork, and chicken are commercially available. A retort food is a food sealed in an airtight, lightproof container and subjected to a pressurization heating sterilization process. In particular, one sealed in a pouch-shaped container is named a retort pouch food, which is widely called “retort food” (a retort pouch food is also herein referred to as a retort food).

It is prescribed that a retort food should be manufactured by filling a container (limited to an airtight, lightproof one), which is obtained by forming a plastic film, a metal foil, or a laminate thereof into a pouch shape or other shape, with a cooked food, sealing the container by heat-melting, and subjecting it to a pressurization heating sterilization process (so-called retort process). Examples of an ingredient of a retort food thus prepared include foods comprising crustacean, typified by shrimp. In a retort food containing crustacean, protein in the crustacean is denatured and texture is changed after the pressurization heating sterilization process. To improve this, for example, there are presented the following methods.

Japanese Patent Laid-Open No. 2020-145973 (PTL 1) discloses a simple method for manufacturing crustacean processed to improve physical properties, which is excellent in texture and has reduced brittleness after a retort process, and a method for manufacturing a retort food. This method includes a first alkali processing step of immersing crustacean into a solution having a pH of 8 to 13, an acid processing step of immersing the crustacean into a solution having a pH of 2 to 5 containing salt after the first alkali processing step, and a second alkali processing step of immersing the crustacean into a solution having a pH of 8 to 13 after the acid processing step.

Japanese Patent No. 5828174 (PTL 2) discloses a method for manufacturing sterilized shrimp capable of easily and inexpensively manufacturing retort-sterilized shrimp having excellent texture and good appearance, flavor, and taste even after retort sterilization, and the retort-sterilized shrimp put in a storing container. The method of this document includes a moisture reducing step of reducing moisture in shrimp, a step of filling a storing container having a predetermined head space with the moisture-reduced shrimp and sealing the container, and a sterilizing step of sterilizing the sealed container with heat and pressure. The invention of this patent is characterized by reducing solubilization and decomposition of collagen at the time of sterilization with heat and pressure by reducing moisture in shrimp for use in a retort food.

Japanese Patent No. 5197100 (PTL 3) discloses a method for manufacturing retort shrimp realizing plump and resilient texture without exhibiting brittle texture even after a retort process. This manufacturing method performs a retort process after a step of immersing a shrimp ingredient sequentially in a transglutaminase solution, salt water of a predetermined concentration or more or salt powder, and a phosphate solution.

Besides the retort foods of shrimp, for example, there are known retort foods of animal protein ingredients, including seafood such as clam, squid, scallop, and crab, and animal meat such as beef, pork, and chicken.

Japanese Patent No. 3844700 (PTL 4) discloses a method for manufacturing a processed food including a process of contacting with acid or alkali, wherein a change in pH of the solution or ingredient is avoided during or after the contacting process. This manufacturing method includes performing the process of contacting a target ingredient with acid or alkali by the use of a pH buffer solution containing the acid or alkali and a buffer substance having a pH buffering action on them. In manufacture of a processed food, if pressurization heating sterilization is performed after an ingredient (such as clam) is processed by an acid or alkali process, the acid or alkali left behind in the ingredient may leak into a sauce or the like of the processed food and change a pH, and the texture of the ingredient may be changed. The invention of this document is for preventing such a change in pH and texture.

Japanese Patent Laid-Open No. H07-8225 (1995) (PTL 5) discloses a method for manufacturing a retort food capable of maintaining texture of an ingredient used in the retort food even after a retort process. This manufacturing method immerses an animal food ingredient in a solution containing transglutaminase, sodium hydrogen carbonate, and common salt, then performs cooking, and performs a retort process for the cooked animal food ingredient. Examples of the animal food ingredient in this document include animal meat such as beef, pork, and chicken, and seafood such as squid, shrimp, scallop, and crab.

Japanese Patent No. 2539653 (PTL 6) discloses a method for manufacturing a heat-sterilized food using seafood and meat, especially a retort food. The manufacturing method of this document immerses unheated seafood and meat in an aqueous solution containing phosphate and common salt and then carries out a pressurization heating process in an aqueous solution including common salt.

Japanese Patent No. 6820685 (PTL 7) discloses a method for manufacturing a meat bun capable of softening the meat filling of the meat bun and reducing the influence on the bun dough. The manufacturing method of this document discloses that collagenase obtained from animal tissues of human, cow, pig, mouse, or the like, bacteria, actinomycetes, or fungi such as Clostridium or Streptomyces, or the like is used to avoid the hardening of meat in the heating process for the meat bun.

### CITATION LIST

### Patent Literature

[PTL 1]: Japanese Patent Laid-Open No. 2020-145973
[PTL 2] Japanese Patent No. 5828174
[PTL 3] Japanese Patent No. 5197100
[PTL 4] Japanese Patent No. 3844700
[PTL 5] Japanese Patent Laid-Open No. H07-8225 (1995)
[PTL 6] Japanese Patent No. 2539653
[PTL 7] Japanese Patent No. 6820685

### SUMMARY OF THE INVENTION

### Technical Problem

In a protein ingredient-containing food, especially a retort food including seafood, livestock meat, and the like, a pressurization heating sterilization process or the like may denature protein in these ingredients and harden or embrittle the texture of the protein ingredients. In particular, it has been difficult to realize preferable texture in a retort food mainly containing shrimp or the like in a pasta sauce or other retort foods containing animal protein ingredients. In addition, since preferable texture cannot be obtained, a yield of a retort food is low, which also requires improvement.

This disclosure is for solving the above problem and aims to improve texture and a yield of a protein ingredient-containing food (especially a retort food) containing seafood, livestock meat, or the like, by using a texture enhancer for the food.

### Solution to Problem

A first aspect of this disclosure is a texture enhancer for a protein ingredient-containing food. A texture enhancer of a first embodiment of this disclosure comprises:
(a) an alkaline agent;
(b) a protein;
(c) a protease; and
(d) a common salt.

A second embodiment of the texture enhancer of this disclosure is a texture enhancer for a protein ingredient-containing food and comprises:
(a) an alkaline agent;
(b) a protein;
(c) a protease;
(d) a common salt; and
(e) an alginate.

A third embodiment of the texture enhancer of this disclosure is a texture enhancer for a protein ingredient-containing food and comprises:
(a) an alkaline agent;
(b) a protein;
(c) a protease;
(d) a common salt;
(e) an alginate; and
(f) a calcium salt.

In the texture enhancer of this disclosure, it is preferable that the alkaline agent be selected from inorganic acid salts or organic acid salts.

In the texture enhancer of this disclosure, it is preferable that the protein be an animal protein or a plant protein.

In the texture enhancer of this disclosure, it is preferable that the protein ingredient be selected from seafoods or livestock meats. Further, in the texture enhancer of this disclosure, it is preferable that the seafoods be crustaceans.

A second aspect of this disclosure is a method for enhancing texture of a protein ingredient-containing food using the above texture enhancer.

The method for enhancing texture of this disclosure comprises:
(1) a step of providing the above texture enhancer; and
(2) a step of mixing the texture enhancer obtained in the step (1) with an ingredient of the protein ingredient-containing food and performing a heating process.

A third aspect of this disclosure is a method for manufacturing a protein ingredient-containing food.

The method for manufacturing of this disclosure comprises:
(1) a step of providing the above texture enhancer; and
(2) a step of mixing the texture enhancer obtained in the step (1) with an ingredient of the protein ingredient-containing food and performing a heating process.

This disclosure includes a protein ingredient-containing food comprising the above texture enhancer.

### Advantageous Effects of Invention

The texture enhancer of this disclosure can improve a yield of a protein ingredient-containing food, especially a retort food, and enhance the texture of the protein ingredient-containing food.

### DESCRIPTION OF THE INVENTION

This disclosure provides a texture enhancer capable of suppressing denaturation of various protein ingredients such as animal protein ingredients (e.g., livestock meat, animal meat, and seafood including crustacean) and plant protein ingredients (e.g., soybean, broad bean, and pea) in a food containing the protein ingredients (hereinafter also referred to as a protein ingredient-containing food), preventing hardening or embrittlement of the protein ingredients, and enhancing the texture of the protein ingredient-containing food. In this disclosure, the protein ingredient-containing food includes various foods such as a canned product, a freeze-dried product, and a frozen food, especially a retort food containing crustacean. The texture enhancer of this disclosure can improve a yield of a protein ingredient-containing food by suppressing denaturation of a protein ingredient in a food, especially a retort food, containing a protein ingredient including seafood such as shrimp and clam or livestock meat such as pork, beef, and chicken, which is included in the protein ingredient-containing food. This disclosure also provides a method for enhancing texture of a protein ingredient-containing food, especially a retort food, using the texture enhancer, and a method for manufacturing a protein ingredient-containing food, especially a retort food, using the texture enhancer. Further, in this disclosure, a protein ingredient can be put into a container and subjected to a pressurization heating sterilization process after being processed with the texture enhancer of this disclosure. Such a pressurization heating sterilization process is herein also referred to as a retort process or simply a pressurization heating process.

This discloser will be described below in detail.

### 1. Texture Enhancer

A first aspect of this disclosure is a texture enhancer for a protein ingredient-containing food.

### 1) Texture Enhancer of First Embodiment

A texture enhancer of a first embodiment of this disclosure includes (a) an alkaline agent, (b) a protein, (c) a protease, and (d) a common salt. In an embodiment of this disclosure, the texture enhancer can include a solvent and take the form of a solution. The solvent is preferably water. In another embodiment, the texture enhancer of this disclosure is in the form of a solid or powder.

The present inventors have found that in manufacture of various protein ingredient-containing foods including animal protein ingredients (such as livestock meat, animal meat, and seafood including crustacean), plant protein ingredients (such as soybean, broad bean, pea, and rice), and the like, the denaturation of the protein ingredients can be suppressed and the texture can be enhanced by using a texture enhancer including an alkaline agent, protein, protease, and common salt. In particular, the present inventors have found that in manufacture of protein ingredient-containing foods, especially retort foods, containing crustacean such as shrimp (for example, processed products such as a pasta sauce containing seafood such as shrimp and clam and livestock meat such as chicken, pork, and beef), the denaturation of the protein ingredients (such as decomposition and dissolution of protein) contained in the protein ingredient-containing foods can be suppressed and the texture of the protein ingredients can be enhanced by adding the above texture enhancer including the alkaline agent, protein, protease, and common salt to the protein ingredient-containing foods. This makes it possible to enhance the texture of protein ingredient-containing foods, especially retort foods, containing protein ingredients.

### (a) Alkaline Agent

The texture enhancer of this disclosure contains an alkaline agent.

The alkaline agent is not particularly limited provided that it can be used in an ingredient of a protein ingredient-containing food, preferably seafood such as shrimp and clam and livestock meat such as chicken, pork, and beef. Examples are inorganic salts and organic salts. The inorganic salts include sodium carbonate, potassium carbonate, sodium hydrogen carbonate, sodium hydroxide, potassium hydroxide, and calcium carbonate. In this disclosure, for example, sodium carbonate or sodium hydrogen carbonate is preferable and sodium carbonate is more preferable. The organic salts include citrate, malate, lactate, and succinate. Here, the salts include alkali metal salt and alkaline earth metal salt such as sodium salt, potassium salt, calcium salt, and magnesium salt. The organic salts preferably include trisodium citrate, trisodium malate, and calcium lactate. A single kind of alkaline agent may be solely used or two or more kinds of alkaline agents may be combined.

The alkaline agent can enhance texture of an ingredient by being used together with a protein and an enzyme described later.

For example, in the case of a 1 to 5% aqueous solution, the content of alkaline agent in the texture enhancer of this disclosure is, with respect to the total weight of the texture enhancer, 0.1% by weight to 5% by weight, preferably 0.5% by weight to 3% by weight, more preferably 0.5% by weight to 1.3% by weight, further more preferably 0.6% by weight to 1.0% by weight, and most preferably 0.7% by weight to 1.0% by weight. With respect to the texture enhancer exclusive of solvent (solid content), the content of alkaline agent is 10% by weight to 30% by weight, and preferably 10% by weight to 25% by weight.

### (b) Protein

The texture enhancer of this disclosure includes a protein. The protein may be either an animal or plant protein and is not particularly limited as long as it can be added to food. In the texture enhancer of this disclosure, preferred proteins are animal proteins such as plasma protein and collagen, or plant proteins such as pea protein, broad bean protein, soybean protein, and rice protein.

The plasma protein is not particularly limited provided that it can be added to an ingredient for use in a protein ingredient-containing food (herein also simply referred to as an ingredient). For example, it may be any protein that can be added to seafood including crustacean, livestock meat, and the like. The plasma protein can be selected as appropriate depending on an ingredient for use. For example, it may be a livestock-origin plasma protein. In this disclosure, it is more preferable that the plasma protein be derived from meat of livestock such as pig, cattle, or chicken. The plasma protein is commercially available. Alternatively, the plasma protein can be obtained by a method publicly known in this field. For example, it can be obtained by extracting blood from target livestock meat, putting it in a container, processing it with an anticoagulant (for example, salts such as calcium fluoride, sodium citrate, and dipotassium EDTA), applying centrifugation, separating a supernatant fluid, and collecting the resultant.

The protein may be collagen. The collagen is not limited as long as it can be added to an ingredient for use in a protein ingredient-containing food (herein also simply referred to as an ingredient), such as seafood including crustacean and livestock meat. The collagen is commercially available.

The protein may be a plant protein. As the plant protein, publicly-known proteins such as pea protein, broad bean protein, soybean protein, and rice protein can be used. The plant protein is commercially available.

In the texture enhancer of this disclosure, especially preferred proteins are plasma proteins such as livestock-origin plasma protein, or plant proteins such as pea protein, broad bean protein, soybean protein, and rice protein.

For example, in the case of a 1 to 5% aqueous solution, the content of protein in the texture enhancer of this disclosure is, with respect to the total weight of the texture enhancer, 0.2% by weight to 5% by weight, preferably 0.5% by weight to 3% by weight, more preferably 0.6% by weight to 1.3% by weight, further more preferably 0.7% by weight to 1.5% by weight, and most preferably 0.8% by weight to 1.5% by weight. With respect to the texture enhancer exclusive of solvent (solid content), the content of protein is 15% by weight to 40% by weight, and preferably 15% by weight to 30% by weight.

### (c) Enzyme (Protease)

The texture enhancer of this disclosure includes an enzyme. The enzyme can avoid denaturation of an ingredient (such as seafood including crustacean and livestock meat such as chicken, pork and beef) and enhance texture of the ingredient by being used together with the protein of the component (b) and the other components of the texture enhancer of this disclosure. In this disclosure, the enzyme is not particularly limited and can be selected as appropriate depending on a purpose as long as it can realize the above object. For example, the enzyme is not particularly limited provided that it can be used in an ingredient, preferably crustacean such as shrimp, used in a protein ingredient-containing food such as a food containing livestock meat, animal meat, and seafood including crustacean, especially a retort food containing seafood, livestock meat, and the like. In this disclosure, the enzyme includes protease. The protease may be derived from animals, plants, or bacteria.

Examples of the protease include, without limitation, carboxyprotease, carboxypeptidase, aminoprotease, aminopeptidase, aspartic protease, serine protease, metal protease, thiol protease, and metalloproteinase. For example, the protease may be acid protease, neutral protease, or alkaline protease. The protease may be derived from plants, animals, or bacteria. In the texture enhancer of this disclosure, the protease is not limited as long as it has a catalytic function of hydrolyzing protein into peptide or amino acid. Examples of the plant protease include papain, bromelain, ficain, actinidin, and zingibain. Examples of the animal protease include pepsin, trypsin, chymotrypsin, animal collagenase, animal elastase, and animal gelatinase. Examples of the bacterial protease include protease, peptidase, collagenase, elastase, and gelatinase derived from fungi, actinomycetes, bacteria (such as Bacillus bacteria, Aspergillus fungi, Streptomyces bacteria, and Clostridium bacteria), and the like. Specific examples or commercial products of the bacterial protease are described in, for instance, Japanese Patent No. 6756333 and Japanese Patent Laid-Open No. 2021-103956. A single protease may be used solely or two or more kinds of proteases may be combined.

The enzyme may be in the form of a preparation (such as a combination of multiple enzymes or one diluted with dextrin or the like). For example, the enzyme preparation only has to contain protease. The enzyme may be in the form of a single enzyme.

As the enzyme preparation and single enzyme, commercial products can be used.

In general, the texture enhancer of this disclosure may be used as, for example, an aqueous solution of a concentration of about 1 to 5%. For instance, when the texture enhancer of this disclosure having the above concentration of texture enhancer is used to process a protein ingredient by immersion in a liquid amount of 100% with respect to a protein-containing food, the enzyme of the texture enhancer of this disclosure is blended such that it has an activity value of 0.005 to 50 U/g, preferably 0.01 to 10 U/g, more preferably 0.02 to 1 U/g, and further preferably 0.03 to 0.08 U/g when in use. For example, when the same texture enhancer as above is used to process a protein ingredient by tumbling in a liquid amount of 50% with respect to a protein-containing food, the enzyme is blended such that it has an activity value of 0.0025 to 30 U/g, preferably 0.005 to 10 U/g, more preferably 0.01 to 1 U/g, and further preferably 0.01 to 0.05 U/g when in use. Incidentally, it is desirable that the preferable activity value when the aqueous solution of the above concentration is used be adjusted as appropriate depending on a pH of a sauce or the like used in a retort process, a processing time, and the like. Further, with respect to the texture enhancer exclusive of solvent (solid content), it is preferable to blend the enzyme such that it has an activity value of 0.1 to 100 U/g, preferably 0.5 to 50 U/g, more preferably 0.5 to 10 U/g, and further preferably 0.5 to 5 U/g when in use.

The protease has a potential for denaturing protein ingredients for use in a protein ingredient-containing food, especially a retort food, but can suppress denaturation of ingredients (such as livestock meat, animal meat, seafood including crustacean, and plant), especially crustacean such as shrimp and livestock meat, in the process of food manufacturing such as a heating process, and enhance texture of a protein ingredient-containing food, especially a retort food, by being used together with the component (a), component (b), and component (d), especially the protein of the component (b), including animal protein and plant protein.

The content of enzyme (protease) in the texture enhancer of this disclosure is, when the enzyme is blended to have the above preferable activity range, 0.05% by weight to 1% by weight, and preferably 0.1% by weight to 0.5% by weight, with respect to the total weight of the texture enhancer (for example, in the case of a 1 to 5% aqueous solution). With respect to the texture enhancer exclusive of solvent (solid content), the content of enzyme (protease) is 1% by weight to 15% by weight, preferably 2.0% by weight to 12% by weight, and more preferably 2.5% by weight to 6.0% by weight, when the enzyme is blended to have the above preferable activity range.

### (d) Common Salt

The texture enhancer of this disclosure contains a common salt. The common salt is not limited provided that it can be used in a protein ingredient-containing food such as a retort food or added to seafood including crustacean, livestock meat, and the like. Commercially available salts for food can be used.

The common salt can enhance texture of an ingredient by being used together with the other components (a) to (c) of the texture enhancer of this disclosure.

For example, protein in edible meat or the like includes salt-soluble proteins such as myosin, actomyosin, and actin. It is expected that the use of a salt such as common salt in a suitable concentration will gel these proteins, improve a yield in food manufacturing, and maintain or enhance texture.

For example, in the case of a 1 to 5% aqueous solution, the content of common salt in the texture enhancer of this disclosure is 0.1% by weight to 2% by weight, preferably 0.5% by weight to 1.5% by weight, and more preferably 1% by weight to 1.5% by weight, with respect to the total weight of the texture enhancer. With respect to the texture enhancer exclusive of solvent (solid content), the content of common salt is 20% by weight to 40% by weight, preferably 20% by weight to 35% by weight, more preferably 25% by weight to 35% by weight, and further more preferably 25% by weight to 30% by weight, with respect to the total weight of the texture enhancer.

The texture enhancer of the first embodiment of this disclosure includes the above component (a) to component (d), but the inclusion of the enzyme may conceivably advance decomposition of a protein ingredient such as seafood including crustacean or livestock meat. In this disclosure, in order to maintain the original texture of a protein ingredient (such as seafood and livestock meat), it is especially preferable to use the protein (component (b) above) such as animal or plant protein in combination with the enzyme (component (c) above).

### 2) Texture Enhancer of Second Embodiment

A texture enhancer of a second embodiment of this disclosure includes (a) an alkaline agent, (b) a protein, (c) a protease, (d) a common salt, and (e) an alginate. In an embodiment of this disclosure, the texture enhancer can include a solvent and take the form of a solution. The solvent is preferably water. In another embodiment, the texture enhancer of this disclosure is in the form of a solid or powder.

The components (a) to (d) of the texture enhancer of the second embodiment are as explained in the texture enhancer of the first embodiment.

### (e) Alginate

The texture enhancer of the second embodiment of this disclosure includes (e) an alginate in addition to the components (a) to (d) of the texture enhancer of the first embodiment. The alginate includes an alkali metal salt, alkaline earth metal salt, and the like of alginic acid. The preferred alginate is an alkali metal salt of alginic acid, and more preferably sodium alginate or calcium alginate. The alginate is not limited as long as it can be used in a protein ingredient-containing food such as a retort food, or added to seafood including crustacean, livestock meat, and the like. The alginate is commercially available.

The alginate can be gelled to form a heat-resistant gel. This heat-resistant gel can increase the stability of a protein ingredient.

For example, in the case of a 1 to 5% aqueous solution, the content of alginate in the texture enhancer of this disclosure is 0.01% by weight to 0.5% by weight, and preferably 0.02% by weight to 0.2% by weight with respect to the total weight of the texture enhancer. With respect to the texture enhancer exclusive of solvent (solid content), the content of alginate is 1% by weight to 10% by weight, preferably 2% by weight to 5% by weight, and more preferably 2% by weight to 4% by weight, with respect to the total weight of the texture enhancer.

### 3) Texture Enhancer of Third Embodiment

A texture enhancer of a third embodiment of this disclosure includes (a) an alkaline agent, (b) a protein, (c) a protease, (d) a common salt, (e) an alginate, and (f) a calcium salt. In an embodiment of this disclosure, the texture enhancer can include a solvent and take the form of a solution. The solvent is preferably water. In another embodiment, the texture enhancer of this disclosure is in the form of a solid or powder.

The components (a) to (d) of the texture enhancer of the third embodiment are as explained in the texture enhancer of the first embodiment, and the component (e) alginate is as explained in the texture enhancer of the second embodiment.

### (f) Calcium Salt

The texture enhancer of the third embodiment of this disclosure includes (f) a calcium salt in addition to the components (a) to (e) of the texture enhancer of the second embodiment. The calcium salt is not particularly limited provided that it can be added to food. For example, it may be any calcium salt that can be used in a retort food or added to seafood including crustacean, livestock meat, and the like. For example, the calcium salt is not particularly limited as long as it is an inorganic calcium salt, organic calcium salt, or the like and can be used in a protein ingredient-containing food, especially in a retort food. Examples of the calcium salt include, without limitation, calcium carbonate, calcium chloride, calcium lactate, calcium gluconate, calcium acetate, and calcium citrate. The calcium salt is commercially available.

The calcium salt can react with an alginate to form a heat-resistant gel. This heat-resistant gel can increase the stability of a protein ingredient.

For example, in the case of a 1 to 5% aqueous solution, the content of calcium salt in the texture enhancer of this disclosure is 0.01% by weight to 5% by weight, preferably 0.02% by weight to 1% by weight, and more preferably 0.02 to 0.5% by weight, with respect to the total weight of the texture enhancer. With respect to the texture enhancer exclusive of solvent (solid content), the content of calcium salt is 1% by weight to 10% by weight, and preferably 1% by weight to 5% by weight.

### Method for Preparing Texture Enhancer

The texture enhancer of this disclosure can be prepared by dissolving each of the component (a) to component (f) corresponding to the texture enhancer of any of the above first to third embodiments in a solvent such as water and mixing them. It is preferable to adjust the obtained solution to have a pH of 3 to 11, and preferably 4 to 11. In this disclosure, it is especially preferable to adjust the pH from a neutral to alkali zone. After the process of mixing with an ingredient of a protein ingredient-containing food, it is more preferable to adjust the pH from a neutral to weak alkali zone. A yield and texture can be further improved by adjusting the pH from a neutral to alkali or weak alkali zone.

For the adjustment of the pH of the texture enhancer of this disclosure, a pH adjuster commonly usable in food can be suitably used without limitation. Examples of the pH adjuster include organic acids such as citric acid, lactic acid, and tartaric acid, and various buffers usable in food. That is, organic acids such as citric acid, lactic acid, and tartaric acid, various buffers, and the like can be added to the above components (a), (b), (c), and (d) in such amounts as to obtain an acid to alkaline, especially neutral to alkaline aqueous solution (for example, a 4% aqueous solution of a pH of 7 to 11), whereby the texture enhancer of this disclosure can be prepared as an aqueous solution of a pH within this range. In particular, in the texture enhancer of this disclosure, it is preferable that the pH be a neutral to weak alkaline pH (for example, a pH of 7 to 10 when a 4% aqueous solution is used) after the process of mixing with an ingredient of a protein ingredient-containing food. By setting the pH within this range, the texture enhancer of this disclosure can improve a yield and texture of a protein ingredient-containing food.

The texture enhancer of this disclosure can also be prepared as a powder by using the above components in a powder form and mixing them with other arbitrary components. Alternatively, the texture enhancer of this disclosure can be prepared as a powder by preparing a texture enhancer in a solution form obtained as explained above and drying the obtained solution by spray drying or the like. The powder texture enhancer can be directly added to an ingredient when in use. Alternatively, after the powder texture enhancer is dissolved in water or the like and an aqueous solution of a suitable concentration is obtained, the texture enhancer of this disclosure can be added to or used in tumbling of an ingredient.

When the texture enhancer of this disclosure is used as a solution, the texture enhancer can be added to an ingredient for use in an amount equal to or less than 100%. In this disclosure, the texture enhancer can be used at a concentration of preferably 0.5% by weight to 60% by weight, more preferably 1% by weight to 60% by weight, or further more preferably 10% by weight to 50% by weight, with respect to an ingredient for use. When the texture enhancer of this disclosure is a solution, a solvent is preferably water. When the texture enhancer of this disclosure is used as a powder, the texture enhancer can be used at a concentration of 0.05% by weight to 15% by weight, preferably 0.1% by weight to 10% by weight, and more preferably 1 to 5% by weight, with respect to an ingredient for use.

The texture enhancer of this disclosure may include various additional additives in order to adjust texture. For example, a seasoning can be mixed with the texture enhancer of this disclosure. The seasoning is not particularly limited. Any seasoning commonly useable in an ingredient can be used without limitation. Further, the seasoning can be contained at any concentration unless it affects texture, flavor, and the like of a product using the texture enhancer of this disclosure. As other additives, at least one component selected from emulsifier, lactoprotein, gelatin, and albumen can be added to adjust texture such as juiciness, elasticity, chewiness, resilience, and smoothness. Examples of the emulsifier include glycerol fatty acid ester, polyglycerol fatty acid ester, organic acid monoglyceride, sorbitan fatty acid ester, propylene glycol fatty acid ester, sucrose fatty acid ester, and lecithin. Examples of the other additives include saccharides such as sucrose, glucose, fructose, and various sugar alcohols; starch and flour; sweeteners such as stevia and aspartame; dextrin; organic acids and salts thereof (such as citric acid, malic acid, lactic acid, tartaric acid, and salts thereof), components having an antibacterial action such as glycine and DL-Alanine; seasoning and/or taste components; flavorings; coloring agents; ferulic acid; tea extract; and thickening agents (gelling agents) such as glucomannan, carrageenan, xanthan gum, and alginate. These additives can be selected as appropriate depending on the purpose of using the additives.

These additional additives may be mixed together at the time of mixing the components (a), (b), (c), (d), (e), and (f) described above, or mixed separately. An addition amount of additional additive is not particularly limited. It can be selected as appropriate depending on the purpose of using the additive.

The texture enhancer of this disclosure formed as stated above exhibits the effect of suppressing denaturation of protein in an ingredient to which the texture enhancer is added and enhancing the texture of the ingredient and a protein ingredient-containing food (especially a retort food).

### 2. Method for Enhancing Texture of Protein Ingredient-Containing Food Using Texture Enhancer

A second aspect of this disclosure is a method for enhancing texture of a protein ingredient-containing food, especially a retort food, using the texture enhancer of this disclosure described above. The enhancing method of this disclosure includes the following steps of:
(1) providing the texture enhancer of this disclosure, and
(2) mixing the texture enhancer obtained in the step (1) with an ingredient of a protein ingredient-containing food and performing a heating process.

### <Step (1)>

The step (1) is a step of providing the texture enhancer of this disclosure. The texture enhancer in this step can be prepared according to the procedure explained in the above method for preparing the texture enhancer. This step (1) may comprise a step of preparing the texture enhancer according to the above procedure of preparing the texture enhancer, or a step of providing the texture enhancer that has already been prepared following the above procedure of preparing the texture enhancer or another procedure.

### <Step (2)>

In the step (2), an ingredient of a protein ingredient-containing food, for example seafood including crustacean such as shrimp, livestock meat, or the like, is processed with the texture enhancer provided in the step (1).

A method of processing the ingredient is not particularly limited and can be selected as appropriate according to a purpose. For example, when the texture enhancer of the step (1) is a solution, there are a method of adding the ingredient to the solution and mixing them, a method of performing tumbling of the ingredient in the solution, and a method of spraying or applying the solution to the ingredient. These methods may be each used solely or two or more of them may be combined. As another method of processing the ingredient, when the powder texture enhancer is used, there is a method of directly adding it to the ingredient and mixing them.

More specifically, in this disclosure, when the texture enhancer of this disclosure is in the form of a solution, there is a method of adding it to the ingredient and mixing them by rubbing, hand kneading, or simple mixing, or by means of a mixer such as a three-roll machine or tumbler, or the like. In addition, there is a method of performing tumbling of the ingredient in a solution containing the texture enhancer for a predetermined time (for example, 0.5 hours to one hour) and letting the solution permeate through the ingredient. Further, there is a method of spraying or applying the solution to the ingredient or immersing the ingredient in the solution and letting it stand for a predetermined time (for example, 0.5 hours to 24 hours). Incidentally, the texture enhancer and the protein ingredient can be mixed also by a mixing method obtained by combining the above methods.

In the methods of this disclosure, after the texture enhancer of this disclosure and the protein ingredient are mixed to obtain the protein ingredient processed with the texture enhancer, a primary heating process (including a cooking process of the protein ingredient processed with the texture enhancer) or the like can be carried out as necessary. Next, the obtained protein ingredient is put into a container and a pressurization heating process is carried out. In this disclosure, common procedures and conditions for a heating process of a protein ingredient processed with a texture enhancer can be applied to the primary heating process. The pressurization heating process can be generally carried out at 50° C. to 150° C. for one minute to one hour, and preferably at a temperature of 90° C. to 130° C. in a range from three minutes to 30 minutes. In this disclosure, “heating process” indicates a process including both of the process of the pressurization heating process alone in the retort process or the like, and the primary heating process and the subsequent pressurization heating process of the protein ingredient processed with the texture enhancer of this disclosure.

By thus processing the ingredient, the texture of the ingredient can be enhanced and the texture of a protein ingredient-containing food (especially a retort food) can be also enhanced.

Further, when the texture enhancer of this disclosure is in the form of a powder, the texture enhancer can be directly mixed with the ingredient. Examples of the mixing method include rubbing, hand kneading, simple mixing, or mixing by a three-roll machine, tumbler, or the like. The texture of the ingredient can be thus enhanced.

The type of ingredient to which the texture enhancer of this disclosure can be added is not particularly limited and everything usable as food can be used. For example, the texture enhancer of this disclosure is effective in enhancing texture of crustacean such as shrimp and crab, especially shrimp. Examples of species of shrimp include giant tiger prawn, kuruma prawn, Alaskan pink shrimp, green tiger prawn, black tiger shrimp, whiteleg shrimp, whiskered velvet shrimp, broad velvet shrimp, greasyback shrimp, Chinese white shrimp, shiba shrimp, botan shrimp, white shrimp, Japanese spiny lobster, fleshy prawn, lobster, and blunt slipper lobster. Examples of species of crab include red king crab, snow crab, horsehair crab, brown king crab, red snow crab, swimming crab, helmet crab, blue king crab, Japanese spider crab, Asian paddle crab, golden king crab, spanner crab, Japanese mitten crab, Japanese freshwater crab, ghost crab, Asian shore crab, brown crab, and Chinese mitten crab.

Besides the crustaceans, examples of the ingredient include livestock meats such as beef, pork, sheep meat, horse meat, and chicken. In addition to the above livestock meat ingredients, the texture enhancer of this disclosure is also usable in animal meats such as venison, wild boar meat, bear meat, and whale meat. Further, in addition to the above crustaceans and meats, the texture enhancer of this disclosure is also usable in seafood meats and plants. Examples of the seafood meats include fishes such as Alaska Pollock, Okhotsk atka mackerel, Japanese jack mackerel, sardine, red bigeye, golden threadfin bream, silver croaker, largehead hairtail, daggertooth pike conger, starspotted smooth-hound, blue shark, crimson seabream, and Indo-Pacific blue marlin, and shell meats such as squid, scallop, and clam. Examples of the plants include seeds of Oryza plants, Triticum plants, Hordeum plants, and Avena plants, and beans such as soybean, pea, chickpea, and broad bean.

Of the above ingredients, a specific ingredient described above can be used solely or multiple types can be used in combination. Further, the above ingredients are commercially available as perishable products, processed products (including precooked ones), frozen products, and the like.

When the texture enhancer of this disclosure is mixed with an ingredient, the content of the texture enhancer is not particularly limited and can be selected as appropriate depending on a purpose. In this disclosure, an addition amount of the texture enhancer (exclusive of solvent) is a weight percentage of 0.2% to 10%, preferably 0.5% to 10%, and more preferably 1 to 5%, per 1 kg ingredient. Incidentally, when the texture enhancer of this disclosure is added as a solution to an ingredient, it is only necessary to prepare a solution containing the component (a), component (b), component (c), component (d), component (e), and/or component (f) of the texture enhancer of any of the first to third embodiments of this disclosure such that the above weight percentage is achieved, and add the solution to the ingredient. More specifically, for example, a 1 to 5%, preferably 4% aqueous solution of the texture enhancer of this disclosure can be added in an amount of 50% by weight of the total weight of the ingredient.

### 3. Method for Manufacturing Protein Ingredient-Containing Food Using Texture Enhancer

A third aspect of this disclosure is a method for manufacturing a protein ingredient-containing food, such as a retort food, using the above texture enhancer of this disclosure. The manufacturing method of this disclosure includes the following steps of:
(1) providing the texture enhancer of this disclosure, and
(2) mixing the texture enhancer obtained in the step (1) with an ingredient of a protein ingredient-containing food and performing a heating process.

### <Step (1)>

The step (1) is a step of providing the texture enhancer of this disclosure. The texture enhancer in this step can be prepared according to the procedure explained in the above method for preparing the texture enhancer. This step (1) may comprise a step of preparing the texture enhancer following the above procedure of preparing the texture enhancer, or a step of providing the texture enhancer that has already been prepared according to the above procedure of preparing the texture enhancer or another procedure.

### <Step (2)>

In the step (2), an ingredient of a protein ingredient-containing food, for example seafood including crustacean such as shrimp, livestock meat, or the like, is processed with the texture enhancer provided in the step (1).

A method of mixing the ingredient is not particularly limited and can be selected as appropriate according to a purpose. This step can use the same procedure as the step (2) of the method for enhancing texture using the texture enhancer described above (second aspect).

The method for enhancing texture and the method for manufacturing a protein ingredient-containing food of this disclosure can further include an additional step.

The additional step is not limited and can be selected as appropriate depending on a purpose unless the effect of this disclosure is impaired. For example, in the case of a retort food, the method can include a step of preparing a retort food after mixing the texture enhancer of this disclosure with a protein ingredient in the step (2) above and heating the mixture (primary heating) as necessary. Incidentally, when the texture enhancer of this disclosure is used, the effect of the texture enhancer can be sometimes improved by primary heating. Further, the preparation of a retort food may include steps such as cooking of the retort food and a pressurization heating process (retort process) including sterilization. For the cooking and pressurization heating process of the retort food, common conditions and procedures known in this technical field can be used. For example, the pressurization heating sterilization process includes performing a pressurization heating process for a cooked food in an autoclave. Additionally, when a frozen product is used as the ingredient, the method can include a thawing step of thawing the frozen ingredient before the above step (2). Further, in the above step (2), the heating process (such as the primary heating process) may include a step of cooking the protein ingredient-containing food (for example, various steps such as stewing, grilling, and steaming).

A food using the texture enhancer of this disclosure is preferably a retort food but is not limited to this. Examples of the food include a canned product, freeze-dried product, and frozen food. For example, when the protein ingredient-containing food is a canned product, it is only necessary to use a can container instead of a retort pouch in the step (2). For example, after the process is performed with the texture enhancer of this disclosure and the obtained protein ingredient is subjected to the primary heating process as necessary, the resultant only has to be put into a can container and subjected to the pressurization heating process as explained above as to the retort food. In the case of a freeze-dried product, frozen food, or the like, after the primary heating process and the pressurization heating process are applied as necessary in the same manner as for the step (2) above, the obtained food can undergo various steps such as freeze drying and refrigeration processing. Well-known methods in this field can be applied to these steps. In this disclosure, “protein ingredient-containing food” includes a protein ingredient itself processed with the texture enhancer of this disclosure.

According to the method for manufacturing a protein ingredient-containing food using the texture enhancer of this disclosure, the texture of the above ingredient itself can be enhanced and the texture of a food containing the ingredient can also be enhanced. More specifically, according to the method for enhancing texture and the method for manufacturing a protein ingredient-containing food using the texture enhancer of this disclosure, a unique texture excellent in chewiness, resilience, and the like can be achieved as a result of suppressing denaturation of protein in the protein ingredient explained above. Incidentally, the chewiness of crustacean including shrimp can be evaluated based on a plump feeling of an ingredient. For example, a plump feeling of a food can be evaluated by trained panelists (e.g., five panelists) conducting a sensory inspection of the ingredient by a rating method. In the case of seafood such as clam and meat such as chicken, pork, and beef, the texture can also be evaluated based on tenderness, cohesiveness of meat fibers, and the like.

### Example 1

This disclosure will be explained further in detail by examples, but the technical scope of this disclosure is not limited to the following examples.

Materials and devices that were used in the examples are shown below. Incidentally, an aqueous solution of a texture enhancer is herein also simply referred to as “processing liquid.”

### <Ingredients>

Shrimp: 5 (size: 71/90) (Ebisho Corporation)
Boiled clam: 5 (commercial product)
Chicken breast (5 cuts) (made by Preco Foods Corporation)
Beef round (5 cuts) (made by Preco Foods Corporation)
Tomato sauce (product name: Kagome Basic Tomato Sauce (made by Kagome Co., Ltd.))

### Various Materials

Alkaline agent
Sodium carbonate (NaCO3)
   Product name: Soda Ash (made by Soda Ash Japan Co., Ltd.)
Organic acid salt
   Product name: Trisodium Citrate (made by Fuso Chemical Co., Ltd.) (Trisodium Citrate)
Organic acid
   Product name: Citric Acid (made by Fuso Chemical Co., Ltd.)
Protein
Plasma protein
   Product name: AProPork (made by APC Europe S.L.U.)
Pea protein
   Product name: Empro (registered trademark) E86 HV (made by Emsland Group)
Collagen protein
   Product name: ScanProTMFCP 75/SF (made by Essentia Protein Solutions Pte. Ltd.)
Enzyme (powder)
Enzyme preparation (protease (1)) made by Nagase ChemteX Corporation
Enzyme preparation (protease (2)) having an activity value twice as much as that of protease (1) (made by Nagase ChemteX Corporation)
Protease (3) high activity protease (made by Nagase ChemteX Corporation)
Common salt
Product name: Carefully-Selected Superfine Salt Uzushio Fine Grain (made by Naruto Salt Mfg. Co., Ltd)
Sodium alginate
Product name: Kimica Algin (made by KIMICA Corporation)
Calcium lactate
Product name: Fermentation Calcium Lactate (made by Showa Kako Corporation)

### <Devices>

Oven
Steam convection oven (made by Nichiwa Electric Corporation)
Autoclave
High-pressure steam sterilizer KTS-2346 (made by Alp, Inc.)

In the following examples, a percentage of each numerical value is a percent by weight.

A description will be given of evaluation methods in the following examples and comparative examples.

### Evaluation of Retort Sample

### a.) Yield Evaluation

An initial weight (g) of a protein ingredient, a weight (weight after processing) (g) of a tumbling sample (the protein ingredient processed with a 4% texture enhancer aqueous solution through the procedure explained in each of the embodiments), a weight (g) of a primary heating sample of the tumbling sample (the tumbling sample subjected to primary heating), and a weight (g) of a retort sample after a pressurization heating sterilization process (retort process) were measured to calculate the following two types of yields. The yields (%) were calculated by the following formulas:

(Primary/initial) yield (%)=(A/B)×100
A: Weight (g) of the sample after the primary heating of the tumbling sample
B: Initial weight (g) of the protein ingredient

(Retort/initial) yield (%)=(A/B)×100
A: Weight (g) of the retort sample after the pressurization heating sterilization process
B: Initial weight (g) of the protein ingredient

The yield measured for a retort sample directly relates to juiciness and indirectly to resilience and a plump feeling. A sample having a higher numerical value of the yield results in having texture superior in juiciness, resilience, and plump feeling.

### b.) Sensory Inspection Method

Sensory evaluations were made by five trained panelists conducting sensory inspections of juiciness, plump feeling, resilience, taste, flavor, and comprehensive evaluation of retort samples by a rating method. Incidentally, for meat such as chicken and beef, tenderness and cohesiveness of meat fibers were tested instead of the plump feeling. In the sensory inspections by the rating method, on the premise that “juiciness,” “plump feeling,” “tenderness,” “cohesiveness of meat fibers,” “resilience,” “taste,” “flavor,” and “comprehensive evaluation” of a retort sample of Comparative Example 1 were 4.0, evaluations were made on “juiciness,” “plump feeling,” “resilience,” “taste,” “flavor,” and “comprehensive evaluation” of the rest of the samples by rating them from 1 (very bad) through 4 (average) to 7 (very good).

For juiciness, a dry texture was rated very bad (score: 1) and a fine texture was rated very good (score: 7). For a plump feeling, a limp texture was rated very bad (score: 1) and a plump texture was rated very good (score: 7). For tenderness, a hard texture was rated very bad (score: 1) and a tender texture was rated very good (score: 7). For “cohesiveness of meat fibers,” a texture was rated very bad (score: 1) when many meat fibers were broken and rated very good (score: 7) when no meat fibers were broken. For resilience, a texture without resilience was rated very bad (score: 1) and a texture with resilience was rated very good (score: 7). For taste, a bad, hard-to-eat food taste (taste of food) was rated very bad (score: 1) and a nice, easy-to-eat food taste was rated very good (score: 7). For flavor, a flavor with a bad smell was rated very bad (score: 1) and a flavor with no bad smell was rated very good (score: 7).

As to a retort sample, the plump feeling is a necessary force for transforming a protein ingredient of a retort sample such as shrimp and can be an evaluation of denaturation of protein forming the protein ingredient (an index indicating chewiness and plump texture when eating the retort sample).

As to a retort sample, the resilience constitutes an index indicating a resilient feeling when eating the retort sample.

Incidentally, the comprehensive evaluation in the examples and comparative examples shown below is an evaluation of whether the result of evaluating all of the juiciness, plump feeling, tenderness, cohesiveness of meat fibers, resilience, taste, and flavor is desirable for a retort product, that is, the result of comprehensively evaluating the juiciness, plump feeling, tenderness, cohesiveness of meat fibers, resilience, taste, and flavor.

### (I) Examples 1 to 5 and Comparative Example 1

Texture enhancers of Examples 1 to 5 and Comparative Example 1 were prepared according to the constitutions of the respective examples and the constitution of the comparative example shown in Table 1 below.

TABLE 1

| Com- | Comp. | | | | | |
|---|---|---|---|---|---|---|
| ponent | Ex. 1 | Ex. 1 | Ex. 2 | Ex. 3 | Ex. 4 | Ex. 5 |
| NaCO₃ | Not | 21.00% | 21.00% | 21.00% | 21.00% | 21.00% |
| Trisodium | added | 8.00% | 8.00% | 8.00% | 8.00% | 8.00% |
| Citrate | | | | | | |
| Citric acid | | 7.00% | 7.00% | 7.00% | 7.00% | 7.00% |
| Common | | 20.00% | 25.00% | 28.50% | 30.00% | 34.00% |
| salt | | | | | | |
| Protease | | 10.00% | 10.00% | 10.00% | 10.00% | 10.00% |
| (1) | | | | | | |
| Plasma | | 20.00% | 20.00% | 20.00% | 20.00% | 20.00% |
| protein | | | | | | |
| Dextrin | | 14.00% | 9.00% | 5.50% | 4.00% | — |
| Total | | 100.00% | 100.00% | 100.00% | 100.00% | 100.00% |

<Preparation of Texture Enhancer, Shrimp Sample Obtained by Processing Shrimp with Texture Enhancer, and Retort Sample>

The materials were mixed in the blend ratios shown in Examples 1 to 5 in Table 1 above and water was added to prepare the respective texture enhancers (4% aqueous solutions). Each of the obtained texture enhancers was added to edible shrimps to prepare a shrimp sample and further prepare a retort sample. Each sample was prepared following the procedure stated below.
1. The materials such as the alkaline agents “Soda Ash” (made by Soda Ash Japan Co., Ltd.) and trisodium citrate (made by Fuso Chemical Co., Ltd.), plasma protein “AProPork” (made by APC Europe S.L.U.), protease (1) (made by Nagase ChemteX Corporation) or protease (2), common salt (Carefully-Selected Superfine Salt Uzushio Fine Grain, Naruto Salt Mfg. Co., Ltd), and citric acid (made by Fuso Chemical Co., Ltd.) were mixed in water to prepare a texture enhancer as a 4% aqueous solution.
2. The 4% aqueous solution of each of Examples 1 to 5 was added to shrimps (five) in a liquid amount of 50% of the total weight of the shrimps and a tumbling process was performed for one hour.
3. The texture enhancer-added shrimps was tumbled by standing for overnight (18 hours) in a refrigerator at 4° C. to give a shrimp tumbling sample.
4. After standing, the weight (g) (weight after processing) and the properties (pH and amount of sodium) of the solution of the obtained shrimp tumbling sample were measured.
5. The shrimp tumbling sample was subjected to a primary heating process (for five minutes at 90° C. in the steam convection oven), and the weight (g) and the properties of the solution after the primary heating process were measured.
6. The shrimps (five) after the primary heating process were put into a retort pouch, a tomato sauce was added, and the pouch was vacuum-sealed to give a retort sample.
7. The obtained retort sample was subjected to a pressurization heating sterilization process for 20 minutes at 120° C. or 121° C. in the autoclave. The obtained retort sample was cooled down under running water and drained for five minutes.
8. The weight (g) of the obtained retort sample was measured.

The pHs and the amounts of sodium (%) of the shrimp tumbling samples obtained according to the above procedure before and after the primary heating process and the retort samples before and after the pressurization heating sterilization process were measured. The results are shown in Table 2.

As Comparative Example 1, a shrimp sample was processed without using any of the materials for a texture enhancer such as the alkaline agent, trisodium citrate, plasma protein, protease (1), common salt, and citric acid, and the primary heating and the preparation of a retort sample were performed by the steps 5. to 8. in the same manner as for Examples 1 to 5. The retort sample of Comparative Example 1 was measured for its properties (pH and amount of sodium (%)) and weight (g) before and after the pressurization heating sterilization process (retort process). The results are shown in Table 2.

TABLE 2
Evaluation of pH and Amount of Sodium (%)

| | Comp. | | | | | |
|---|---|---|---|---|---|---|
| Process | Ex. 1 | Ex. 1 | Ex. 2 | Ex. 3 | Ex. 4 | Ex. 5 |
| pH before primary heating proces¹⁾ | — | 9.52 | 9.66 | 9.73 | 9.66 | 9.73 |
| pH after primary heating process¹⁾ | — | 7.3 | 7.44 | 8.08 | 7.74 | 7.73 |
| Na before primary heating process¹⁾ | — | 1.43% | 1.65% | 1.74% | 1.84% | 2.00% |
| Na after primary heating process¹⁾ | — | 0.70% | 0.80% | 0.88% | 0.88% | 0.94% |
| pH before pressurization heating | 4.29 | 4.29 | 4.29 | 4.29 | 4.29 | 4.29 |
| sterilization process²⁾ | | | | | | |
| pH after pressurization heating | 4.73 | 4.72 | 4.86 | 4.94 | 4.74 | 4.73 |
| sterilization process²⁾ | | | | | | |
| Na before pressurization heating | 0.77% | 0.77% | 0.77% | 0.77% | 0.77% | 0.77% |
| sterilization process²⁾ | | | | | | |
| Na after pressurization heating | 0.79% | 0.82% | 0.85% | 0.85% | 0.74% | 0.74% |
| sterilization process²⁾ | | | | | | |

¹⁾Result of processing shrimps with 4% aqueous solution of texture enhancer
²⁾Result of preparing tomato sauce retort sample from shrimps processed with 4% aqueous solution of texture enhancer

### Preparation of Texture Enhancer Including Alkaline Agent, Plasma Protein, Protease (1), and Common Salt, and Shrimp Sample and Retort Sample Using the Same

According to “Preparation of Texture Enhancer, Shrimp Sample Obtained by Processing Shrimp with Texture Enhancer, and Retort Sample” above, texture enhancers of Examples 1 to 5 and Comparative Example 1 in Table 1 were prepared and shrimp samples and retort samples were produced.

### Evaluation Results

### (i) Results of Yield Evaluation

Table 3 shows the results of yield evaluation of Examples 1 to 5 and Comparative Example 1.

TABLE 3
Yield Evaluation

| | Comp. Ex. 1 | Ex. 1 | Ex. 2 | Ex. 3 | Ex. 4 | Ex. 5 |
|---|---|---|---|---|---|---|
| (Primary/initial) yield (%) | 55.4% | 84.0% | 82.9% | 88.8% | 87.5% | 89.7% |
| (Retort/initial) yield (%) | 53.5% | 73.7% | 72.6% | 63.1% | 71.1% | 72.6% |

As shown in Table 3, the samples produced by the use of the texture enhancers of this disclosure achieved excellent yields as compared with Comparative Example 1.

### (ii) Results of Sensory Inspection

Table 4 shows the results of evaluation in the sensory inspection of Examples 1 to 5 and Comparative Example 1.

TABLE 4
Results of Sensory Inspection

| Sensory inspection | Comp. Ex. 1 | Ex. 1 | Ex. 2 | Ex. 3 | Ex. 4 | Ex. 5 |
|---|---|---|---|---|---|---|
| Juiciness | 4.0 | 5.0 | 5.0 | 5.2 | 5.6 | 5.2 |
| Plump feeling | 4.0 | 5.2 | 5.4 | 5.4 | 5.4 | 5.6 |
| Resilience | 4.0 | 5.2 | 5.0 | 5.2 | 5.2 | 5.4 |
| Taste | 4.0 | 4.8 | 5.0 | 4.6 | 4.8 | 5.0 |
| Flavor | 4.0 | 5.2 | 5.0 | 5.2 | 5.2 | 5.4 |
| Comprehensive evaluation | 4.0 | 5.0 | 4.8 | 4.8 | 5.0 | 5.2 |
| Total | 24.0 | 30.4 | 30.2 | 30.4 | 31.2 | 31.8 |

The texture enhancers of this disclosure provide excellent results as compared with Comparative Example 1.

### (II) Examples 6 to 9 and Comparative Example 2

The content of alkaline agent in the texture enhancer of this disclosure was considered. According to “Preparation of Texture Enhancer, Shrimp Sample Obtained by Processing Shrimp with Texture Enhancer, and Retort Sample” above, texture enhancers having the blending amounts shown in Table 5 were prepared and shrimp samples and retort samples were produced. Comparative Example 2 is an example in the case of including only the protein and enzyme as active ingredients. Incidentally, as reference examples, the samples of Comparative Example 1 and Example 3 were produced again and evaluated together with Examples 6 to 9.

TABLE 5

| | Comp. | Comp. | | | | | |
|---|---|---|---|---|---|---|---|
| | Ex. 1 | Ex. 2 | Ex. 3 | Ex. 6 | Ex. 7 | Ex. 8 | Ex. 9 |
| Sodium | — | — | 21.00% | 10.00% | 15.00% | 20.00% | 30.00% |
| Carbonate | | | | | | | |
| Trisodium | — | — | 8.00% | — | — | — | — |
| Citrate | | | | | | | |
| Citric acid | — | — | 7.00% | — | — | — | — |
| Common salt | — | 28.50% | 28.50% | 28.50% | 28.50% | 28.50% | 28.50% |
| Dextrin | — | 41.50% | 5.50% | 31.50% | 26.50% | 21.50% | 11.50% |
| Protease (1) | — | 10.00% | 10.00% | 10.00% | 10.00% | 10.00% | 10.00% |
| Plasma protein | — | 20.00% | 20.00% | 20.00% | 20.00% | 20.00% | 20.00% |
| Total | — | 100.00% | 100.00% | 100.00% | 100.00% | 100.00% | 100.00% |

### Evaluation Results

### (i) Evaluation of pH and Amount of Sodium (%)

The pHs and the amounts of sodium (%) of the shrimp tumbling samples of Examples 6 to 9, Comparative Examples 1 and 2, and Example 3 obtained according to the above procedure before and after the primary heating process were measured. The results are shown in Table 6.

TABLE 6
Evaluation of pH and Amount of Sodium (%)

| | Comp. | Comp. | | | | | |
|---|---|---|---|---|---|---|---|
| | Ex. 1 | Ex. 2 | Ex. 3 | Ex. 6 | Ex. 7 | Ex. 8 | Ex. 9 |
| pH | — | 7.51 | 9.77 | 10.69 | 10.86 | 10.98 | 11.1 |
| before | | | | | | | |
| primary | | | | | | | |
| process | | | | | | | |
| pH after | — | 6.11 | 7.97 | 6.91 | 7.45 | 7.98 | 8.76 |
| primary | | | | | | | |
| process | | | | | | | |
| Na | — | 1.11% | 1.82% | 1.37% | 1.54% | 1.68% | 1.91% |
| before | | | | | | | |
| primary | | | | | | | |
| process | | | | | | | |
| Na after | — | 0.56% | 0.92% | 0.68% | 0.83% | 0.89% | 0.90% |
| primary | | | | | | | |
| process | | | | | | | |

### (ii) Results of Yield Evaluation

Table 7 shows the results of yield evaluation of Examples 6 to 9. Comparative Example 2, and Example 3 and Comparative Example 1 as reference examples.

TABLE 7
Yield Evaluation

| | Comp. | Comp. | | | | | |
|---|---|---|---|---|---|---|---|
| | Ex. 1 | Ex. 2 | Ex. 3 | Ex. 6 | Ex. 7 | Ex. 8 | Ex. 9 |
| (Primary/initial) | 54.4% | 65.4% | 87.2% | 68.5% | 80.2% | 86.8% | 96.9% |
| yield (%) | | | | | | | |
| (Retort/initial) yield | 53.9% | 56.4% | 71.2% | 60.0% | 67.3% | 72.1% | 87.2% |
| (%) | | | | | | | |

(iii) Results of Sensory Inspection

Table 8 shows the results of evaluation in the sensory inspection of Examples 6 to 9, Comparative Example 2, and Example 3 and Comparative Example 1 (retested) as reference examples.

TABLE 8
Results of Sensory Inspection

| | Comp. | Comp. | | | | | |
|---|---|---|---|---|---|---|---|
| | Ex. 1 | Ex. 2 | Ex. 3 | Ex. 6 | Ex. 7 | Ex. 8 | Ex. 9 |
| Juiciness | 4.0 | 4.5 | 4.8 | 5.5 | 5.5 | 5.3 | 7.0 |
| Plump feeling | 4.0 | 4.0 | 4.8 | 5.3 | 5.3 | 5.3 | 2.5 |
| Resilience | 4.0 | 4.3 | 5.0 | 4.8 | 4.8 | 4.0 | 2.5 |
| Taste | 4.0 | 4.3 | 4.8 | 5.0 | 5.0 | 4.3 | 3.5 |
| Flavor | 4.0 | 4.5 | 4.8 | 4.8 | 4.8 | 3.8 | 3.0 |
| Comprehensive | 4.0 | 4.3 | 4.5 | 5.0 | 5.0 | 4.3 | 4.5 |
| evaluation | | | | | | | |
| Total | 24.0 | 25.9 | 28.7 | 30.4 | 30.4 | 27.0 | 23.0 |

As shown in Tables 7 and 8, the results of Example 9 are excellent in yield, juiciness, and comprehensive evaluation, but are lower in plump feeling, resilience, taste, and flavor than Comparative Example 1. According to these results, it is preferable that the content of alkaline agent be equal to or less than 30% by weight.

### (III) Examples 3 and 10 to 13 and Comparative Example 3

The content of enzyme (protease) in the texture enhancer of this disclosure was considered. According to “Preparation of Texture Enhancer, Shrimp Sample Obtained by Processing Shrimp with Texture Enhancer, and Retort Sample” above, texture enhancers having the blending amounts shown in Table 9 were prepared and shrimp samples and retort samples were produced. Comparative Example 3 is an example of using no enzyme. Incidentally, the samples of Comparative Example 1 and Example 3 were produced again and evaluated together with Examples 10 to 13 and Comparative Example 3.

TABLE 9

| | Comp. | Comp. | | | | | |
|---|---|---|---|---|---|---|---|
| | Ex. 1 | Ex. 3 | Ex. 10 | Ex. 11 | Ex. 3 | Ex. 12 | Ex. 13 |
| Sodiumu | — | 21.00% | 21.00% | 21.00% | 21.00% | 21.00% | 21.00% |
| Carbonate | | | | | | | |
| Trisodium | — | 8.00% | 8.00% | 8.00% | 8.00% | 8.00% | 8.00% |
| Citrate | | | | | | | |
| Citric acid | — | 7.00% | 7.00% | 7.00% | 7.00% | 7.00% | 7.00% |
| Common | — | 28.50% | 28.50% | 28.50% | 28.50% | 28.50% | 28.50% |
| salt | | | | | | | |
| Dextrin | — | 15.50% | 10.50% | 8.00% | 5.50% | 3.00% | 0.50% |
| Protease | — | — | 5.00% | 7.50% | 10.00% | 12.50% | 15.00% |
| (1) | | | | | | | |
| Plasma | — | 20.00% | 20.00% | 20.00% | 20.00% | 20.00% | 20.00% |
| protein | | | | | | | |
| Total | — | 100.00% | 100.00% | 100.00% | 100.00% | 100.00% | 100.00% |

### Evaluation Results

### (i) Results of Yield Evaluation

Table 10 shows the results of yield evaluation of Examples 3 and 10 to 13, Comparative

Example 3, and Comparative Example 1 as a reference example.

TABLE 10
Yield Evaluation

| | Comp. | Comp. | | | | | |
|---|---|---|---|---|---|---|---|
| | Ex. 1 | Ex. 3 | Ex. 10 | Ex. 11 | Ex. 3 | Ex. 12 | Ex. 13 |
| (Primary/initial) | 57.4% | 84.3% | 82.0% | 83.9% | 82.2% | 80.9% | 79.9% |
| yield (%) | | | | | | | |
| (Retort/initial) | 56.7% | 66.6% | 65.2% | 68.6% | 67.3% | 67.7% | 70.6% |
| yield (%) | | | | | | | |

### (ii) Results of Sensory Inspection

Table 11 shows the results of evaluation in the sensory inspection of Examples 3 and 10 to 13. Comparative Example 3, and Comparative Example 1 as a reference example.

TABLE 11
Results of Sensory Inspection

| | Comp. | Comp. | | | | | |
|---|---|---|---|---|---|---|---|
| | Ex. 1 | Ex. 3 | Ex. 10 | Ex. 11 | Ex. 3 | Ex. 12 | Ex. 13 |
| Juiciness | 4.0 | 5.0 | 5.0 | 5.3 | 5.5 | 5.3 | 5.3 |
| Plump feeling | 4.0 | 4.3 | 5.5 | 5.8 | 5.3 | 5.3 | 4.8 |
| Resilience | 4.0 | 4.3 | 5.5 | 5.5 | 5.0 | 5.0 | 5.0 |
| Taste | 4.0 | 4.8 | 5.0 | 5.0 | 4.8 | 5.0 | 5.0 |
| Flavor | 4.0 | 4.5 | 5.0 | 5.0 | 4.8 | 5.0 | 5.0 |
| Comprehensive | 4.0 | 4.5 | 5.3 | 5.5 | 5.0 | 4.8 | 4.8 |
| evaluation | | | | | | | |
| Total | 24.0 | 27.3 | 31.3 | 32.0 | 30.3 | 30.3 | 29.8 |

As shown in Tables 10 and 11, the results of Examples 3 and 10 to 13 are excellent in yield and sensory inspection as compared with Comparative Examples 1 and 3. According to these results, it is considered preferable that the content of enzyme be 1 to 15% by weight.

### (IV) Examples 14 to 16 and Comparative Example 4

The type of protein and the protease in the texture enhancer of this disclosure were considered. According to “Preparation of Texture Enhancer, Shrimp Sample Obtained by Processing Shrimp with Texture Enhancer, and Retort Sample” above, texture enhancers having the blending amounts shown in Table 12 were prepared and shrimp samples and retort samples were produced. As reference examples, the samples of Comparative Example 1 and Example 3 were produced again and evaluated together with Examples 14 to 16 and Comparative Example 4. Incidentally, Comparative Example 4 is an example of using no protein. The samples of Example 16 and Comparative Example 1 compared with Example 16 were prepared according to the procedure explained in (VI) “Preparation of Texture Enhancer, Protein Ingredient Sample Processed with the Texture Enhancer, and Retort Sample” of Examples 16 and 18 to 20, which will be described later.

TABLE 12

| | Comp. | Comp. | | | | |
|---|---|---|---|---|---|---|
| | Ex. 1 | Ex. 4 | Ex. 3 | Ex. 14 | Ex. 15 | Ex. 16 |
| Sodiumu | Not | 21.0% | 21.0% | 21.0% | 21.0% | 20.0% |
| Carbonate | added | | | | | |
| Trisodium Citrate | | 8.0% | 8.0% | 8.0% | 8.0% | 8.0% |
| Citric acid | | 7.0% | 7.0% | 7.0% | 7.0% | 7.0% |
| Common salt | | 28.5% | 28.5% | 28.5% | 28.5% | 30.0% |
| Dextrin | | 25.5% | 5.5% | 5.5% | 5.5% | 10.0% |
| Protease (1) | | 10.0% | 10.0% | 10.0% | 10.0% | — |
| Protease (2) | | — | — | — | — | 5.0% |
| Plasma protein | | — | 20.0% | — | — | — |
| Pea protein | | — | — | 20.0% | — | 20.0% |
| Collagen protein | | — | — | — | 20.0% | — |
| Total | | 100.0% | 100.0% | 100.0% | 100.0% | 100.0% |

### (i) Results of Yield Evaluation

Table 13 shows the results of yield evaluation of Examples 14 to 16, Comparative Example 4, and Example 3 and Comparative Example 1 as reference examples. Incidentally, the results of Example 16 were obtained by preparing samples again together with Comparative Example 1 and testing them separately from Example 14 and 15, Comparative Example 4, and Example 3.

TABLE 13
Yield Evaluation

| | Comp. | Comp. | | | | |
|---|---|---|---|---|---|---|
| | Ex. 1 | Ex. 4 | Ex. 3 | Ex. 14 | Ex. 15 | Ex. 16 |
| (Primary/initial) | 58.9% | 80.2% | 85.1% | 80.4% | 80.2% | 74.0% |
| yield (%) | | | | | | |
| (Retort/initial) | 54.5% | 62.7% | 67.2% | 62.4% | 63.3% | 68.3% |
| yield (%) | | | | | | |

### (ii) Results of Sensory Inspection

Table 14 shows the results of evaluation in the sensory inspection of Examples 14 to 16, Comparative Example 4, and Example 3 and Comparative Example 1 (retested) as reference examples. Incidentally, the results of Example 16 were obtained by preparing samples again together with Comparative Example 1 and testing them separately from Example 14 and 15, Comparative Example 4, and Example 3.

TABLE 14
Results of Sensory Inspection

| Sensory | Comp. | Comp. | | | | |
|---|---|---|---|---|---|---|
| inspection | Ex. 1 | Ex. 4 | Ex. 3 | Ex. 14 | Ex. 15 | Ex. 16 |
| Juiciness | 4.0 | 5.0 | 5.4 | 5.8 | 5.8 | 5.4 |
| Plump feeling | 4.0 | 4.6 | 5.6 | 6.0 | 5.4 | 5.6 |
| Resilience | 4.0 | 5.0 | 5.6 | 6.0 | 5.6 | 5.0 |
| Taste | 4.0 | 4.6 | 4.8 | 4.8 | 4.8 | 5.0 |
| Flavor | 4.0 | 4.6 | 4.8 | 5.0 | 4.8 | 5.0 |
| Comprehensive | 4.0 | 5.0 | 5.2 | 5.4 | 5.0 | 5.0 |
| evaluation | | | | | | |
| Total | 24.0 | 28.8 | 31.4 | 33.0 | 31.4 | 31.0 |

As can be understood from Table 13 and Table 14, the plasma protein, pea protein, and collagen protein are suitable as components of the texture enhancer of this disclosure. Further, the protease with the doubled activity achieved the same results of sensory inspection as those of Examples 14 to 15 even through the content was reduced by half.

### (V) Example 17 and Comparative Example 5

The type of enzyme in the texture enhancer of this disclosure was considered. According to “Preparation of Texture Enhancer, Shrimp Sample Obtained by Processing Shrimp with Texture Enhancer, and Retort Sample” above, texture enhancers having the blending amounts shown in Table 15 were prepared and shrimp samples and retort samples were produced. Incidentally, as reference examples, the samples of Comparative Example 1 and Example 3 were produced again and evaluated together with Example 17 and Comparative Example 5. Incidentally, Comparative Example 5 is an example of using no enzyme.

TABLE 15

| | Comp. | Comp. | | |
|---|---|---|---|---|
| | Ex. 1 | Ex. 5 | Ex. 3 | Ex. 17 |
| Sodiumu | Not added | 21.00% | 21.00% | 21.00% |
| Carbonate | | | | |
| Trisodium Citrate | | 8.00% | 8.00% | 8.00% |
| Citric acid | | 7.00% | 7.00% | 7.00% |
| DL-malic acid | | — | — | — |
| Common salt | | 28.50% | 28.50% | 28.50% |
| Dextrin | | 15.50% | 5.50% | 15.50% |
| Plasma protein | | 20.00% | 20.00% | 20.00% |
| Protease (1) | | — | 10.00% | — |
| Protease (3) | | — | — | 0.005% |
| Total | | 100.00% | 100.00% | 100.00% |

### Evaluation Results

### (i) Evaluation of pH and Amount of Sodium (%)

The pHs and the amounts of sodium (%) of the shrimp tumbling samples of Example 17, Comparative Examples 1 and 5, and Example 3 obtained according to the above procedure before and after the primary heating process were measured. The results are shown in Table 16.

TABLE 16
Evaluation of pH and Amount of Sodium (%)

| | Comp. | Comp. | | |
|---|---|---|---|---|
| | Ex. 1 | Ex. 5 | Ex. 3 | Ex. 17 |
| pH before primary | — | 9.74 | 9.77 | 9.80 |
| process | | | | |
| pH after primary process | — | 7.24 | 7.40 | 7.69 |
| Na before primary | — | 1.69 | 1.77 | 1.76 |
| process | | | | |
| Na after primary process | — | 0.81 | 0.92 | 0.80 |

### (ii) Results of Yield Evaluation

Table 17 shows the results of yield evaluation of Example 17, Comparative Example 5, and Example 3 and Comparative Example 1 as reference examples.

TABLE 17
Yield Evaluation

| | Comp. | Comp. | | |
|---|---|---|---|---|
| | Ex. 1 | Ex. 5 | Ex. 3 | Ex. 17 |
| (Primary/initial) yield (%) | 55.2% | 82.2% | 81.1% | 84.0% |
| (Retort/initial) yield (%) | 61.6% | 73.6% | 73.0% | 70.4% |

(iii) Results of Sensory Inspection

Table 18 shows the results of evaluation in the sensory inspection of Example 17, Comparative Example 5, and Example 3 and Comparative Example 1 (retested) as reference examples.

TABLE 18
Results of Sensory Inspection

| | Comp. Ex. 1 | Comp. Ex. 5 | Ex. 3 | Ex. 17 |
|---|---|---|---|---|
| Juiciness | 4.0 | 5.0 | 5.2 | 4.9 |
| Plump feeling | 4.0 | 4.2 | 5.5 | 5.1 |
| Resilience | 4.0 | 4.2 | 5.3 | 5.1 |
| Taste | 4.0 | 4.1 | 4.3 | 4.2 |
| Flavor | 4.0 | 4.5 | 5.1 | 4.3 |
| Comprehensive | 4.0 | 4.4 | 5.1 | 5.2 |
| evaluation | | | | |
| Total | 24.0 | 26.4 | 30.5 | 28.8 |

### (VI) Examples 16 and 18 to 20

The texture enhancers of this disclosure were prepared using the constitutions shown in Table 19.

TABLE 19
Constitution of Texture Enhancer

| | Comp. Ex. 1 | Ex. 16 | Ex. 18 | Ex. 19 | Ex. 20 |
|---|---|---|---|---|---|
| Sodiumu | Not | 20.0% | 20.0% | 20.0% | 20.0% |
| Carbonate | processed | | | | |
| Trisodium Citrate | | 8.0% | 8.0% | 8.0% | 8.0% |
| Citric acid | | 7.0% | 7.0% | 7.0% | 7.0% |
| Common salt | | 30.0% | 30.0% | 30.0% | 30.0% |
| Protease (2) | | 5.0% | 5.0% | 5.0% | 5.0% |
| Pea protein | | 20.0% | 20.0% | 20.0% | 20.0% |
| Sodium alginate | | — | 3.0% | — | 3.0% |
| Calcium lactate | | — | — | 5.0% | 5.0% |
| Dextrin | | 10.0% | 7.0% | 5.0% | 2.0% |
| Total | — | 100.0% | 100.0% | 100.0% | 100.0% |

The texture enhancers having the constitutions shown in Table 19 were used to produce texture enhancer aqueous solutions (4%). Shrimp was used as the protein ingredient of Examples 16 and 18 to 20. More specifically, the materials were mixed in the blend ratios shown in Table 19 above and water was added to prepare the respective texture enhancer aqueous solutions (processing liquids) (4%). Each of the obtained texture enhancer processing liquids was added to the protein ingredient to prepare a test sample and further prepare a retort sample. Each sample was prepared according to the procedure stated below.

<Preparation of Texture Enhancer, Protein Ingredient Sample Processed with the Texture Enhancer, and Retort Sample>
1. The materials shown in Table 19 were mixed in water to prepare texture enhancer aqueous solutions (4%).
2. The processing liquid of each of Examples 16 and 18 to 20 was added to the protein ingredient (five shrimps) in a liquid amount of 50% of the total weight of the protein ingredient (shrimps) and a tumbling process was performed for one hour.
3. The texture enhancer-added protein ingredient obtained by tumbling process was drained for five minutes to give a tumbling sample (protein ingredient sample).
4. The weight (g) (weight after processing) and the properties (pH and amount of sodium) of the solution of the obtained tumbling sample were measured.
5. The tumbling sample was subjected to a primary heating process (for five minutes at 90° C. in the steam convection oven). After cooling down, the weight (g) and the properties of the solution after the primary heating process were measured.
6. The protein ingredient (five shrimps) after the primary heating process was put into a retort pouch, a tomato sauce was added, and the pouch was vacuum-sealed to give a retort sample.
7. The obtained retort sample was subjected to a pressurization heating sterilization process for 20 minutes at 121° C. in the autoclave. The obtained retort sample was cooled down under running water for 30 minutes and drained for five minutes.
8. The weight (g) of the obtained retort sample was measured.

Incidentally, in Examples 16 and 18 to 20 and Comparative Example 1, the samples of Comparative Example 1 were produced again and evaluated together with Examples 16 and 18 to 20.

### Evaluation Results

### (i) Evaluation of pH and Amount of Sodium (%)

The pHs and the amounts of sodium (%) of the shrimp tumbling samples of Examples 16 and 18 to 20 obtained according to the above procedure before and after the primary heating process were measured. The results are shown in Table 20.

TABLE 20
Evaluation of pH and Amount of Sodium (%)

| | Comp. | | | | |
|---|---|---|---|---|---|
| | Ex. 1 | Ex. 16 | Ex. 18 | Ex. 19 | Ex. 20 |
| pH before primary | — | 9.62 | 9.6 | 9.72 | 9.76 |
| process | | | | | |
| pH after primary | — | 8.31 | 8.24 | 8.11 | 8.09 |
| process | | | | | |
| Na before primary | — | 1.72 | 1.74 | 1.72 | 1.76 |
| process | | | | | |
| Na after primary | — | 0.9 | 0.97 | 1.00 | 0.99 |
| process | | | | | |

### (ii) Results of Yield Evaluation

Table 21 shows the results of yield evaluation of Examples 16 and 18 to 20 and Comparative Example 1.

TABLE 21
Yield Evaluation

| | Comp. | | | | |
|---|---|---|---|---|---|
| | Ex. 1 | Ex. 16 | Ex. 18 | Ex. 19 | Ex. 20 |
| (Primary/initial) | 69.2% | 74.0% | 74.1% | 73.3% | 73.2% |
| yield (%) | | | | | |
| (Retort/initial) | 57.2% | 68.3% | 69.4% | 68.1% | 69.7% |
| yield (%) | | | | | |

(iii) Results of Sensory Inspection

Table 22 shows the results of evaluation in the sensory inspection of Example 16 (retested), Examples 18 to 20, and Comparative Example 1 (retested).

TABLE 22
Results of Sensory Inspection

| | Comp. Ex. 1 | Ex. 16 | Ex. 18 | Ex. 19 | Ex. 20 |
|---|---|---|---|---|---|
| Juiciness | 4.0 | 5.4 | 5.8 | 5.6 | 5.8 |
| Plump feeling | 4.0 | 5.6 | 6.2 | 5.8 | 6.4 |
| Resilience | 4.0 | 5.0 | 5.6 | 5.0 | 5.8 |
| Taste | 4.0 | 5.0 | 5.0 | 5.0 | 5.2 |
| Flavor | 4.0 | 5.0 | 5.0 | 5.0 | 5.2 |
| Comprehensive | 4.0 | 5.0 | 5.6 | 5.0 | 5.8 |
| evaluation | | | | | |
| Total | 24.0 | 31.0 | 33.2 | 31.4 | 34.2 |

As shown in Tables 21 and 22, the results of Examples 16 and 18 to 20 are excellent in yield, juiciness, and comprehensive evaluation. According to these results, increasing the activity of protease makes it possible to reduce the content of protease in the texture enhancer of this disclosure and add sodium alginate and calcium lactate as components.

### (VII) Examples 20 to 24

The texture enhancer of this disclosure was prepared using the constitution shown in Table 23.

TABLE 23
Constitution of Texture Enhancer

| | Comp. Ex. 1 | Exs. 20 to 24 |
|---|---|---|
| Sodiumu | Not processed | 20.0% |
| Carbonate | | |
| Trisodium Citrate | | 8.0% |
| Citric acid | | 7.0% |
| Common salt | | 30.0% |
| Protease (2) | | 5.0% |
| Pea protein | | 20.0% |
| Sodium alginate | | 3.0% |
| Calcium lactate | | 5.0% |
| Dextrin | | 2.0% |
| Total | — | 100.0% |

The texture enhancer having the constitution shown in Table 23 was used to produce processing liquids having a concentration range of texture enhancer from 1% by weight to 5% by weight, as shown in Table 24. Shrimp was used as the protein ingredient of Examples 20 to 24. More specifically, the materials were mixed in the blend ratio shown in Table 23 above and water was added to prepare the respective texture enhancer aqueous solutions (processing liquids) (1 to 5%). Each of the obtained texture enhancer processing liquids was added to the protein ingredient (five shrimps) to prepare a test sample and further prepare a retort sample. Each sample was prepared according to the procedure explained in Examples 16 and 18 to 20.

Incidentally, in Examples 20 to 24, the samples of Comparative Example 1 and Example 20 were prepared again and evaluated together with Examples 21 to 24.

TABLE 24
Concentration of Texture Enhancer Aqueous
Solution (Processing Liquid)

| | Comp. | | | | | |
|---|---|---|---|---|---|---|
| | Ex. 1 | Ex. 21 | Ex. 22 | Ex. 23 | Ex. 20 | Ex. 24 |
| Concentration | Not | 1.0 | 2.0 | 3.0 | 4.0 | 5.0 |
| of processing | processed | | | | | |
| liquid (%) | | | | | | |

### Evaluation Results

### (i) Evaluation of pH and Amount of Sodium (%)

The pHs and the amounts of sodium (%) of the shrimp tumbling samples of Examples 20 to 24 and Comparative Example 1 obtained following the above procedure before and after the primary heating process were measured. The results are shown in Table 25.

TABLE 25
Evaluation of pH and Amount of Sodium (%)

| | Comp. Ex. 1 | Ex. 21 | Ex. 22 | Ex. 23 | Ex. 20 | Ex. 24 |
|---|---|---|---|---|---|---|
| pH before primary | — | 9.94 | 9.94 | 9.82 | 9.76 | 9.71 |
| process | | | | | | |
| pH after primary process | — | 7.71 | 7.85 | 8.09 | 8.31 | 8.45 |
| Na before primary | — | 0.49 | 0.92 | 1.37 | 1.74 | 2.11 |
| process | | | | | | |
| Na after primary process | — | 0.33 | 0.54 | 0.74 | 0.88 | 1.08 |

### (ii) Results of Yield Evaluation

Table 26 shows the results of yield evaluation of Examples 20 to 24 and Comparative Example 1.

TABLE 26
Yield Evaluation

| | Comp. Ex. 1 | Ex. 21 | Ex. 22 | Ex. 23 | Ex. 20 | Ex. 24 |
|---|---|---|---|---|---|---|
| (Primary/initial) yield (%) | 81.0% | 91.4% | 94.6% | 93.9% | 90.6% | 88.5% |
| (Retort/initial) yield (%) | 80.2% | 79.7% | 85.1% | 84.4% | 87.0% | 88.4% |

(iii) Results of Sensory Inspection

Table 27 shows the results of evaluation in the sensory inspection of Examples 20 to 24 and Comparative Example 1 (retested).

TABLE 27
Results of Sensory Inspection

| | Comp. | | | | | |
|---|---|---|---|---|---|---|
| | Ex. 1 | Ex. 21 | Ex. 22 | Ex. 23 | Ex. 20 | Ex. 24 |
| Juiciness | 4.0 | 4 | 4.8 | 5.2 | 5.6 | 6.2 |
| Plump feeling | 4.0 | 4.4 | 4.8 | 5.6 | 6.0 | 5.6 |
| Resilience | 4.0 | 4.0 | 4.4 | 5.0 | 5.8 | 5.4 |
| Taste | 4.0 | 4.0 | 4.0 | 4.6 | 4.8 | 4.8 |
| Flavor | 4.0 | 4.0 | 4.2 | 4.8 | 4.8 | 4.8 |
| Comprehensive | 4.0 | 4.0 | 4.2 | 5.0 | 5.2 | 5.0 |
| evaluation | | | | | | |
| Total | 24.0 | 24.4 | 26.4 | 30.2 | 32.2 | 31.8 |

As shown in Tables 26 and 27, the results of Examples 20 to 24 are excellent in yield, juiciness, and comprehensive evaluation, but the results of Example 21 are equal to those of Comparative Example 1. According to these results, it is considered preferable to use the texture enhancer of this disclosure at a concentration of about 2% or more, and more preferable to use it at a concentration of about 3% or more.

### (VIII) Examples 20 and 25 to 28

In Examples 20 and 25 to 28, the range of concentration of alginate was considered.

The texture enhancers of this disclosure were prepared using the constitutions shown in Table 28.

TABLE 28
Constitution of Texture Enhancer

| | Comp. | | | | | |
|---|---|---|---|---|---|---|
| | Ex. 1 | Ex. 25 | Ex. 26 | Ex. 27 | Ex. 20 | Ex. 28 |
| Sodiumu | Not | 20.00% | 20.00% | 20.00% | 20.00% | 20.00% |
| Carbonate | processed | | | | | |
| Trisodium | | 8.00% | 8.00% | 8.00% | 8.00% | 8.00% |
| Citrate | | | | | | |
| Citric acid | | 7.00% | 7.00% | 7.00% | 7.00% | 7.00% |
| Common salt | | 30.00% | 30.00% | 30.00% | 30.00% | 30.00% |
| Protease (2) | | 5.00% | 5.00% | 5.00% | 5.00% | 5.00% |
| Pea protein | | 20.00% | 20.00% | 20.00% | 20.00% | 20.00% |
| Sodium | | 0.00% | 1.00% | 2.00% | 3.00% | 4.00% |
| alginate | | | | | | |
| Calcium | | 5.00% | 5.00% | 5.00% | 5.00% | 5.00% |
| lactate | | | | | | |
| Dextrin | | 5.00% | 4.00% | 3.00% | 2.00% | 1.00% |
| Total | — | 100.00% | 100.00% | 100.00% | 100.00% | 100.00% |

The texture enhancers having the constitutions shown in Table 28 were used to produce processing liquids containing the texture enhancers at a concentration of 4%. Shrimp was used as the protein ingredient of Examples 20 and 25 to 28. More specifically, the materials were mixed in the blend ratios shown in Table 28 above and water was added to prepare the respective texture enhancer aqueous solutions (processing liquids) (4%). Each of the obtained texture enhancer processing liquids was added to the protein ingredient (five shrimps) to prepare a test sample and further prepare a retort sample. Each sample was prepared according to the procedure explained in Examples 16 and 18 to 20.

Incidentally, in Examples 20 and 25 to 28, the samples of Comparative Example 1 were produced again and evaluated together with Examples 20 and 25 to 28.

### Evaluation Results

### (i) Evaluation of pH and Amount of Sodium (%)

The pHs and the amounts of sodium (%) of the shrimp tumbling samples of Examples 20 and 25 to 28 obtained according to the above procedure before and after the primary heating process were measured. The results are shown in Table 29.

TABLE 29
Evaluation of pH and Amount of Sodium (%)

| | Comp. Ex. 1 | Ex. 25 | Ex. 26 | Ex. 27 | Ex. 20 | Ex. 28 |
|---|---|---|---|---|---|---|
| pH before primary process | — | 9.75 | 9.72 | 9.77 | 9.74 | 9.78 |
| pH after primary process | — | 7.18 | 7.09 | 7.07 | 7.16 | 7.14 |
| Na before primary process | — | 9.75 | 9.72 | 9.77 | 9.74 | 9.78 |
| Na after primary process | — | 7.18 | 7.09 | 7.07 | 7.16 | 7.14 |

### (ii) Results of Yield Evaluation

Table 30 shows the results of yield evaluation of Examples 20 and 25 to 28 and Comparative Example 1.

TABLE 30
Yield Evaluation

| | Comp. | | | | | |
|---|---|---|---|---|---|---|
| | Ex. 1 | Ex. 25 | Ex. 26 | Ex. 27 | Ex. 20 | Ex. 28 |
| (Primary/initial) | 65.1% | 75.1% | 76.0% | 77.3% | 75.4% | 76.7% |
| yield (%) | | | | | | |
| (Retort/initial) | 61.5% | 72.1% | 71.8% | 74.0% | 74.1% | 74.4% |
| yield (%) | | | | | | |

(iii) Results of Sensory Inspection

Table 31 shows the results of evaluation in the sensory inspection of Example 20 (retested), Examples 25 to 28, and Comparative Example 1 (retested).

TABLE 31
Results of Sensory Inspection

| | Comp. | | | | | |
|---|---|---|---|---|---|---|
| | Ex. 1 | Ex. 25 | Ex. 26 | Ex. 27 | Ex. 20 | Ex. 28 |
| Juiciness | 4.0 | 5.0 | 5.0 | 5.0 | 5.4 | 5.6 |
| Plump feeling | 4.0 | 5.0 | 5.2 | 6.0 | 6.0 | 5.8 |
| Resilience | 4.0 | 5.0 | 5.0 | 5.6 | 6.0 | 5.6 |
| Taste | 4.0 | 4.6 | 4.8 | 5.0 | 5.0 | 5.0 |
| Flavor | 4.0 | 4.6 | 4.8 | 5.0 | 4.8 | 4.8 |
| Comprehensive | 4.0 | 5.0 | 5.0 | 5.0 | 5.0 | 5.0 |
| evaluation | | | | | | |
| Total | 24.0 | 29.2 | 29.8 | 31.6 | 32.2 | 31.8 |

As shown in Tables 30 and 31, the results of Examples 20 and 25 to 28 are excellent in yield, juiciness, and comprehensive evaluation. In particular, the excellent effect was realized when the concentration of sodium alginate was 3% by weight.

### (IX) Examples 29 to 33 and Comparative Example 6

Examples 29 to 33 and Comparative Example 6 are examples of using clam as the protein ingredient.

In Examples 29 to 33, the texture enhancer had the constitution shown in Table 32. Incidentally, Comparative Example 6 is an example of not using the texture enhancer of this disclosure.

TABLE 32
Constitution of Texture Enhancer

| | Comp. Ex. 6 | Exs. 29 to 33 |
|---|---|---|
| Sodiumu | Not processed | 20.00% |
| Carbonate | | |
| Trisodium Citrate | | 8.00% |
| Citric acid | | 7.00% |
| Common salt | | 30.00% |
| Protease (2) | | 5.00% |
| Pea protein | | 20.00% |
| Sodium alginate | | 3.00% |
| Calcium lactate | | 5.00% |
| Dextrin | | 2.00% |
| Total | — | 100.00% |

The texture enhancer having the constitution shown in Table 32 was used to produce processing liquids having a concentration range of texture enhancer from 1% by weight to 5% by weight, as shown in Table 33. Clam was used as the protein ingredient of these examples. More specifically, the materials were mixed in the blend ratio shown in Table 32 above and water was added to prepare the respective texture enhancer aqueous solutions (processing liquids) (1 to 5%). Each of the obtained texture enhancer processing liquids was added to the protein ingredient (clam was used in Examples 29 to 33 and Comparative Example 6) to prepare a test sample and further prepare a retort sample. Each sample was prepared according to the procedure explained below.

<Preparation of Texture Enhancer, Protein Ingredient Sample Processed with the Texture Enhancer, and Retort Sample>
1. The materials shown in Table 32 were mixed in water to prepare texture enhancer aqueous solutions (1 to 5%).
2. The processing liquid of each of Examples 29 to 33 was added to the protein ingredient (five frozen boiled clams) in a liquid amount of 50% of the total weight of the protein ingredient (clams) and an immersion process was performed for two hours.
3. The texture enhancer-added protein ingredient obtained by the immersion process was drained for five minutes to give a tumbling sample (protein ingredient sample).
4. The weight (g) (weight after processing) and the properties (pH and amount of sodium) of the solution of the obtained tumbling sample were measured.
5. The tumbling sample was subjected to a primary heating process (for five minutes at 90° C. in the steam convection oven). After cooling down, the weight (g) and the properties of the solution after the primary heating process were measured.
6. The protein ingredient (five clams) after the primary heating process was put into a retort pouch, a tomato sauce was added, and the pouch was vacuum-sealed to give a retort sample.
7. The obtained retort sample was subjected to a pressurization heating sterilization process for 20 minutes at 121ºC in the autoclave. The obtained retort sample was cooled down under running water for 30 minutes and drained for five minutes.
8. The weight (g) of the obtained retort sample was measured.

Incidentally, in Examples 29 to 33 and Comparative Example 6, the texture enhancer of this disclosure was not used for Comparative Example 6; the steps 5. to 8. were performed for the clam protein ingredient according to the above preparation procedure to perform primary heating, produce a retort sample, and make evaluation.

TABLE 33
Concentration of Texture
Enhancer Aqueous Solution (Processing Liquid)

| | Comp. | Ex. | Ex. | Ex. | Ex. | Ex. |
|---|---|---|---|---|---|---|
| | Ex. 6 | 29 | 30 | 31 | 32 | 33 |
| Concentration of | Not | 1.0 | 2.0 | 3.0 | 4.0 | 5.0 |
| processing liquid (%) | processed | | | | | |

### Evaluation Results

### (i) Evaluation of pH and Amount of Sodium (%)

The pHs and the amounts of sodium (%) of the clam tumbling samples of Examples 29 to 33 and Comparative Example 6 obtained according to the above procedure before and after the primary heating process were measured. The results are shown in Table 34.

TABLE 34
Evaluation of pH and Amount of Sodium (%)

| | Comp. | | | | | |
|---|---|---|---|---|---|---|
| | Ex. 6 | Ex. 29 | Ex. 30 | Ex. 31 | Ex. 32 | Ex. 33 |
| pH before primary | — | 9.68 | 9.68 | 9.58 | 9.57 | 9.53 |
| process | | | | | | |
| pH after primary | — | 8.31 | 8.74 | 8.88 | 9.04 | 9.07 |
| process | | | | | | |
| Na before primary | — | 0.46 | 0.90 | 1.33 | 1.73 | 2.12 |
| process | | | | | | |
| Na after primary | — | 0.53 | 0.78 | 1.03 | 1.27 | 1.05 |
| process | | | | | | |

### (ii) Results of Yield Evaluation

Table 35 shows the results of yield evaluation of Examples 29 to 33 and Comparative Example 6.

TABLE 35
Yield Evaluation

| | Comp. | | | | | |
|---|---|---|---|---|---|---|
| | Ex. 6 | Ex. 29 | Ex. 30 | Ex. 31 | Ex. 32 | Ex. 33 |
| (Primary/initial) | 81.0% | 91.4% | 94.6% | 93.9% | 90.6% | 88.5% |
| yield (%) | | | | | | |
| (Retort/initial) | 80.2% | 79.7% | 85.1% | 84.4% | 87.0% | 88.4% |
| yield (%) | | | | | | |

(iii) Results of Sensory Inspection

Table 36 shows the results of evaluation in the sensory inspection of Examples 29 to 33 and Comparative Example 6.

TABLE 36
Results of Sensory Inspection

| | Comp. | | | | | |
|---|---|---|---|---|---|---|
| | Ex. 6 | Ex. 29 | Ex. 30 | Ex. 31 | Ex. 32 | Ex. 33 |
| Juiciness | 4.0 | 4.4 | 4.4 | 4.8 | 4.8 | 5.2 |
| Plump feeling | 4.0 | 4.0 | 4.8 | 5.0 | 5.6 | 5.8 |
| Resilience | 4.0 | 4.0 | 4.4 | 5.0 | 5.0 | 5.2 |
| Taste | 4.0 | 4.2 | 4.4 | 4.6 | 4.6 | 5.0 |
| Flavor | 4.0 | 4.2 | 4.4 | 4.6 | 5.0 | 5.2 |
| Comprehensive | 4.0 | 4.2 | 4.6 | 5.0 | 5.2 | 5.4 |
| evaluation | | | | | | |
| Total | 24.0 | 25.0 | 27.0 | 29.0 | 30.2 | 31.8 |

As shown in Tables 35 and 36, the results of Examples 29 to 33 are excellent in yield and sensory inspection. These results show that the texture enhancer of this disclosure is also effective for seafood such as clam.

### (X) Examples 34 to 38 and Comparative Example 7

Examples 34 to 38 and Comparative Example 7 are examples of using chicken as the protein ingredient.

In Examples 34 to 38, the texture enhancer had the constitution shown in Table 37. Incidentally, Comparative Example 7 is an example of not using the texture enhancer of this disclosure.

TABLE 37
Constitution of Texture Enhancer

| | Comp. Ex. 7 | Exs. 34 to 38 |
|---|---|---|
| Sodiumu | Not processed | 20.00% |
| Carbonate | | |
| Trisodium Citrate | | 8.00% |
| Citric acid | | 7.00% |
| Common salt | | 30.00% |
| Protease (2) | | 5.00% |
| Pea protein | | 20.00% |
| Sodium alginate | | 3.00% |
| Calcium lactate | | 5.00% |
| Dextrin | | 2.00% |
| Total | — | 100.00% |

The texture enhancer having the constitution shown in Table 37 was used to produce processing liquids having a concentration range of texture enhancer from 1% by weight to 5% by weight, as shown in Table 38. Chicken breast was used as the protein ingredient of these examples. More specifically, the materials were mixed in the blend ratio shown in Table 37 above and water was added to prepare the respective texture enhancer aqueous solutions (processing liquids) (1 to 5%). Each of the obtained texture enhancer processing liquids was added to the protein ingredient (chicken breast was used in Examples 34 to 38 and Comparative Example 7) to prepare a test sample and further prepare a retort sample. Each sample was prepared according to the procedure explained below.

<Preparation of Texture Enhancer, Protein Ingredient Sample Processed with the Texture Enhancer, and Retort Sample>
1. The materials shown in Table 37 were mixed in water to prepare texture enhancer aqueous solutions (1 to 5%).
2. The processing liquid of each of Examples 34 to 38 was added to the protein ingredient (five chicken breasts) in a liquid amount of 50% of the total weight of the protein ingredient (chicken breasts) and a tumbling process was performed for one hour.
3. The texture enhancer-added protein ingredient obtained by the tumbling process was drained for five minutes to give a tumbling sample (protein ingredient sample).
4. The weight (g) (weight after processing) and the properties (pH and amount of sodium) of the solution of the obtained tumbling sample were measured.
5. The tumbling sample was subjected to a primary heating process (for 10 minutes at 200° C. in the steam convection oven). After cooling down (30 minutes), the weight (g) and the properties of the solution after the primary heating process were measured.
6. The protein ingredient (five chicken breasts) after the primary heating process was put into a retort pouch, a tomato sauce was added, and the pouch was vacuum-sealed to give a retort sample.
7. The obtained retort sample was subjected to a pressurization heating sterilization process for 20 minutes at 121° C. in the autoclave. The obtained retort sample was cooled down under running water for 30 minutes and drained for five minutes.
8. The weight (g) of the obtained retort sample was measured.

Incidentally, in Examples 34 to 38 and Comparative Example 7, the texture enhancer of this disclosure was not used for Comparative Example 7; the steps 5. to 8. were performed for the chicken breast protein ingredient according to the above preparation procedure to perform primary heating, produce a retort sample, and make evaluation.

TABLE 38
Concentration of Texture Enhancer Aqueous
Solution (Processing Liquid)

| | Comp. | Ex. | Ex. | Ex. | Ex. | Ex. |
|---|---|---|---|---|---|---|
| | Ex. 7 | 34 | 35 | 36 | 37 | 38 |
| Concentration of | Not | 1.0 | 2.0 | 3.0 | 4.0 | 5.0 |
| processing liquid (%) | processed | | | | | |

### Evaluation Results

### (i) Evaluation of pH and Amount of Sodium (%)

The pHs and the amounts of sodium (%) of the chicken breast tumbling samples of Examples 34 to 38 and Comparative Example 7 obtained according to the above procedure before and after the primary heating process were measured. The results are shown in Table 39.

TABLE 39
Evaluation of pH and Amount of Sodium (%)

| | Comp. | | | | | |
|---|---|---|---|---|---|---|
| | Ex. 7 | Ex. 34 | Ex. 35 | Ex. 36 | Ex. 37 | Ex. 38 |
| pH before primary | — | 9.90 | 9.78 | 9.73 | 9.69 | 9.65 |
| process | | | | | | |
| pH after primary | — | 6.45 | 6.80 | 6.87 | 7.24 | 7.72 |
| process | | | | | | |
| Na before primary | — | 0.46 | 0.98 | 1.36 | 1.75 | 2.14 |
| process | | | | | | |
| Na after primary | — | 0.49 | 0.70 | 0.87 | 1.05 | 1.21 |
| process | | | | | | |

### (ii) Results of Yield Evaluation

Table 40 shows the results of yield evaluation of Examples 34 to 38 and Comparative Example 7.

TABLE 40
Yield Evaluation

| | Comp. Ex. 7 | Ex. 34 | Ex. 35 | Ex. 36 | Ex. 37 | Ex. 38 |
|---|---|---|---|---|---|---|
| (Primary/initial) | 70.4% | 67.9% | 71.6% | 73.6% | 78.5% | 83.6% |
| yield (%) | | | | | | |
| (Retort/initial) | 67.5% | 67.1% | 70.5% | 71.1% | 76.9% | 77.8% |
| yield (%) | | | | | | |

(iii) Results of Sensory Inspection

Table 41 shows the results of evaluation in the sensory inspection of Examples 34 to 38 and Comparative Example 7. Incidentally, in Examples 34 to 38 and Comparative Example 7, the evaluation was made also for the cohesiveness of fibers of chicken. The cohesiveness of meat fibers is for evaluating the breakage of meat fibers; a higher numerical value indicates less breakage of meat fibers and less crumbly feeling of meat. A scarcity of breakage of meat fibers indicates good finished quality after cooking and reduced damage to muscle fibers of a protein-containing ingredient in a heating process.

TABLE 41
Results of Sensory Inspection

| | Comp. | | | | | |
|---|---|---|---|---|---|---|
| | Ex. 7 | Ex. 34 | Ex. 35 | Ex. 36 | Ex. 37 | Ex. 38 |
| Juiciness | 4.0 | 4.4 | 4.8 | 5.4 | 5.4 | 5.4 |
| Tenderness | 4.0 | 4.8 | 5.4 | 5.6 | 5.8 | 5.6 |
| Cohesiveness | 4.0 | 4.4 | 4.8 | 5.6 | 5.4 | 5.8 |
| of meat fibers | | | | | | |
| Resilience | 4.0 | 4.4 | 5.0 | 5.2 | 5.0 | 5.2 |
| Taste | 4.0 | 4.2 | 4.8 | 5.0 | 4.8 | 5.0 |
| Flavor | 4.0 | 4.2 | 4.6 | 5.0 | 4.8 | 5.0 |
| Comprehensive | 4.0 | 4.4 | 5.2 | 5.6 | 5.4 | 5.4 |
| evaluation | | | | | | |
| Total | 28.0 | 30.8 | 34.6 | 37.4 | 36.6 | 37.4 |

As shown in Tables 40 and 41, the results of Examples 34 to 38 are excellent in yield and sensory inspection. These results show that the texture enhancer of this disclosure is also effective for livestock meat such as chicken.

### (XI) Examples 39 to 43 and Comparative Example 8

Examples 39 to 43 and Comparative Example 8 are examples of using beef round as the protein ingredient.

In Examples 39 to 43, the texture enhancer had the constitution shown in Table 42. Incidentally, Comparative Example 8 is an example of not using the texture enhancer of this disclosure.

TABLE 42
Constitution of Texture Enhancer

| | Comp. Ex. 8 | Exs. 39 to 43 |
|---|---|---|
| Sodiumu | Not processed | 20.00% |
| Carbonate | | |
| Trisodium Citrate | | 8.00% |
| Citric acid | | 7.00% |
| Common salt | | 30.00% |
| Protease (2) | | 5.00% |
| Pea protein | | 20.00% |
| Sodium alginate | | 3.00% |
| Calcium lactate | | 5.00% |
| Dextrin | | 2.00% |
| Total | — | 100.00% |

The texture enhancer having the constitution shown in Table 42 was used to produce processing liquids having a concentration range of texture enhancer from 1% by weight to 5% by weight, as shown in Table 43. Beef round was used as the protein ingredient of these examples. More specifically, the materials were mixed in the blend ratio shown in Table 42 above and water was added to prepare the respective texture enhancer aqueous solutions (processing liquids) (1 to 5%). Each of the obtained texture enhancer processing liquids was added to the protein ingredient (beef round was used in Examples 39 to 43 and Comparative Example 8) to prepare a test sample and further prepare a retort sample. Each sample was prepared according to the procedure explained below.

<Preparation of Texture Enhancer, Protein Ingredient Sample Processed with the Texture Enhancer, and Retort Sample>
1. The materials shown in Table 42 were mixed in water to prepare texture enhancer aqueous solutions (1 to 5%).
2. The processing liquid of each of Examples 39 to 43 was added to the protein ingredient (five beef rounds) in a liquid amount of 50% of the total weight of the protein ingredient (beef rounds) and a tumbling process was performed for one hour.
3. The texture enhancer-added protein ingredient obtained by the tumbling process was drained for five minutes to give a tumbling sample (protein ingredient sample).
4. The weight (g) (weight after processing) and the properties (pH and amount of sodium) of the solution of the obtained tumbling sample were measured.
5. The tumbling sample was subjected to a primary heating process (for 10 minutes at 200° C. in the steam convection oven). After cooling down (30 minutes), the weight (g) and the properties of the solution after the primary heating process were measured.
6. The protein ingredient (five beef rounds) after the primary heating process was put into a retort pouch, a tomato sauce was added, and the pouch was vacuum-sealed to give a retort sample.
7. The obtained retort sample was subjected to a pressurization heating sterilization process for 20 minutes at 121° C. in the autoclave. The obtained retort sample was cooled down under running water for 30 minutes and drained for five minutes.
8. The weight (g) of the obtained retort sample was measured.

Incidentally, in Examples 39 to 43 and Comparative Example 8, the texture enhancer of this disclosure was not used for Comparative Example 8; the steps 5. to 8. were performed for the beef round protein ingredient according to the above preparation procedure to perform primary heating, produce a retort sample, and make evaluation.

TABLE 43
Concentration of Texture
Enhancer Aqueous Solution (Processing Liquid)

| | Comp. | Ex. | Ex. | Ex. | Ex. | Ex. |
|---|---|---|---|---|---|---|
| | Ex. 8 | 39 | 40 | 41 | 42 | 43 |
| Concentration of | Not | 1.0 | 2.0 | 3.0 | 4.0 | 5.0 |
| processing liquid (%) | processed | | | | | |

### Evaluation Results

### (i) Evaluation of pH and Amount of Sodium (%)

The pHs and the amounts of sodium (%) of the beef round tumbling samples of Examples 39 to 43 and Comparative Example 8 obtained according to the above procedure before and after the primary heating process were measured. The results are shown in Table 44.

TABLE 44
Evaluation of pH and Amount of Sodium (%)

| | Comp. | | | | | |
|---|---|---|---|---|---|---|
| | Ex. 8 | Ex. 39 | Ex. 40 | Ex. 41 | Ex. 42 | Ex. 43 |
| pH before primary | — | 9.84 | 9.86 | 9.86 | 9.80 | 9.78 |
| process | | | | | | |
| pH after primary | — | 6.27 | 6.64 | 6.80 | 7.13 | 7.42 |
| process | | | | | | |
| Na before primary | — | 0.45 | 0.91 | 1.31 | 1.71 | 2.13 |
| process | | | | | | |
| Na after primary | — | 0.50 | 0.66 | 0.84 | 1.03 | 1.25 |
| process | | | | | | |

### (ii) Results of Yield Evaluation

Table 45 shows the results of yield evaluation of Examples 39 to 43 and Comparative Example 8.

TABLE 45
Yield Evaluation

| | Comp. | | | | | |
|---|---|---|---|---|---|---|
| | Ex. 8 | Ex. 39 | Ex. 40 | Ex. 41 | Ex. 42 | Ex. 43 |
| (Primary/initial) | 59.0% | 53.4% | 59.3% | 62.6% | 65.4% | 69.1% |
| yield (%) | | | | | | |
| (Retort/initial) | 58.6% | 58.2% | 60.2% | 61.3% | 64.3% | 65.4% |
| yield (%) | | | | | | |

(iii) Results of Sensory Inspection

Table 46 shows the results of evaluation in the sensory inspection of Examples 39 to 43 and Comparative Example 8. Incidentally, in Examples 39 to 43 and Comparative Example 8, the evaluation was made also for the cohesiveness of fibers of beef. The cohesiveness of beef fibers is for evaluating the breakage of meat fibers; a higher numerical value indicates less breakage of meat fibers and less crumbly feeling of meat. A scarcity of breakage of meat fibers indicates good finished quality after cooking and reduced damage to muscle fibers of a protein-containing ingredient in a heating process.

TABLE 46
Results of Sensory Inspection

| | Comp. | | | | | |
|---|---|---|---|---|---|---|
| | Ex. 8 | Ex. 39 | Ex. 40 | Ex. 41 | Ex. 42 | Ex. 43 |
| Juiciness | 4.0 | 4.2 | 4.8 | 5.2 | 5.4 | 5.8 |
| Tenderness | 4.0 | 4.6 | 5.2 | 5.2 | 5.6 | 6.0 |
| Cohesiveness | 4.0 | 4.8 | 5.2 | 5.0 | 5.2 | 5.6 |
| of meat fibers | | | | | | |
| Resilience | 4.0 | 4.6 | 5.2 | 5.2 | 5.6 | 5.8 |
| Taste | 4.0 | 4.8 | 4.8 | 4.8 | 5.0 | 5.4 |
| Flavor | 4.0 | 4.8 | 4.8 | 4.8 | 5.2 | 5.4 |
| Comprehensive | 4.0 | 4.8 | 5.2 | 5.2 | 5.6 | 5.8 |
| evaluation | | | | | | |
| Total | 28.0 | 32.6 | 35.2 | 35.4 | 37.6 | 39.8 |

As shown in Tables 45 and 46, the results of Examples 39 to 43 are excellent in yield and sensory inspection. These results show that the texture enhancer of this disclosure is also effective for livestock meat such as beef.

1-10. (canceled)

11. A texture enhancer for a protein ingredient-containing food, the texture enhancer for the food comprising:
(a) an alkaline agent;
(b) a protein;
(c) a protease; and
(d) a common salt.

12. A texture enhancer for a protein ingredient-containing food, the texture enhancer for the food comprising:
(a) an alkaline agent;
(b) a protein;
(c) a protease;
(d) a common salt; and
(e) an alginate.

13. The texture enhancer according to claim 12, further comprising (f) a calcium salt.

14. The texture enhancer according to claim 11, wherein the alkaline agent is selected from inorganic acid salts or organic acid salts.

15. The texture enhancer according to claim 12, wherein the alkaline agent is selected from inorganic acid salts or organic acid salts.

16. The texture enhancer according to claim 13, wherein the alkaline agent is selected from inorganic acid salts or organic acid salts.

17. The texture enhancer according to claim 11, wherein the protein is an animal protein or a plant protein.

18. The texture enhancer according to claim 12, wherein the protein is an animal protein or a plant protein.

19. The texture enhancer according to claim 13, wherein the protein is an animal protein or a plant protein.

20. The texture enhancer according to claim 11, wherein the protein ingredient is selected from seafoods or livestock meats.

21. The texture enhancer according to claim 12, wherein the protein ingredient is selected from seafoods or livestock meats.

22. The texture enhancer according to claim 13, wherein the protein ingredient is selected from seafoods or livestock meats.

23. The texture enhancer according to claim 20, wherein the seafoods are crustaceans.

24. The texture enhancer according to claim 21, wherein the seafoods are crustaceans.

25. The texture enhancer according to claim 22, wherein the seafoods are crustaceans.

26. A method for enhancing texture of a protein ingredient-containing food, the method comprising:
(1) a step of providing the texture enhancer according to claim 11; and
(2) a step of mixing the texture enhancer obtained in the step (1) with an ingredient of the protein ingredient-containing food and performing a heating process.

27. A method for enhancing texture of a protein ingredient-containing food, the method comprising:
(1) a step of providing the texture enhancer according to claim 12; and
(2) a step of mixing the texture enhancer obtained in the step (1) with an ingredient of the protein ingredient-containing food and performing a heating process.

28. A method for enhancing texture of a protein ingredient-containing food, the method comprising:
(1) a step of providing the texture enhancer according to claim 13; and
(2) a step of mixing the texture enhancer obtained in the step (1) with an ingredient of the protein ingredient-containing food and performing a heating process.

29. A method for manufacturing a protein ingredient-containing food, the method comprising:
(1) a step of providing the texture enhancer according to claim 11; and
(2) a step of mixing the texture enhancer obtained in the step (1) with an ingredient of the protein ingredient-containing food and performing a heating process.

30. A method for manufacturing a protein ingredient-containing food, the method comprising:
(1) a step of providing the texture enhancer according to claim 12; and
(2) a step of mixing the texture enhancer obtained in the step (1) with an ingredient of the protein ingredient-containing food and performing a heating process.

31. A method for manufacturing a protein ingredient-containing food, the method comprising:
(1) a step of providing the texture enhancer according to claim 13; and
(2) a step of mixing the texture enhancer obtained in the step (1) with an ingredient of the protein ingredient-containing food and performing a heating process.

32. A protein ingredient-containing food comprising the texture enhancer according to claim 11.

33. A protein ingredient-containing food comprising the texture enhancer according to claim 12.

34. A protein ingredient-containing food comprising the texture enhancer according to claim 13.
